(19) United States
(12) Patent Application Publication
(10) Pub. No.: US 2026/0301658 A1
(43) Pub. Date: Oct. 1, 2026

(54) DISPLAY PANEL AND DISPLAY APPARATUS

(71) Applicant: Wuhan Tianma Microelectronics Co., Ltd., Wuhan (CN)

(72) Inventors: Shijuan YI, Wuhan (CN); Dongxu XIANG, Wuhan (CN)

(73) Assignee: Wuhan Tianma Microelectronics Co., Ltd., Wuhan (CN)

(21) Appl. No.: 19/577,347

(22) Filed: Mar. 24, 2026

(30) Foreign Application Priority Data
Mar. 25, 2025 (CN) 202510361178.7

(51) Int. Cl. G09G 3/32

(52) U.S. Cl. CPC G09G 3/32; G09G 2300/043; G09G 2300/0819; G09G 2300/0842; G09G 2310/0267; G09G 2310/0286; G09G 2310/08; G09G 2320/0233; G09G 2330/021

(57) ABSTRACT

The present disclosure discloses a display panel and a display apparatus and relates to the field of display technology. The display panel includes pixel circuits arranged in an array, a first driving circuit, and a second driving circuit. A writing module of the pixel circuit is electrically connected to a gate of a driver transistor through a coupling module. A compensation module is electrically connected between a gate and a drain of the driver transistor. Rows of pixel circuits form a pixel group. The first driving circuit includes first shift register units. The first shift register unit is electrically connected to the compensation modules in the rows of pixel circuits in a same pixel group. The second driving circuit includes second shift register units, and the second shift register unit is electrically connected to the writing modules in one row of pixel circuits.

### CROSS-REFERENCE TO RELATED APPLICATIONS

This application claims priority to Chinese patent application No. 202510361178.7, entitled “DISPLAY PANEL AND DISPLAY APPARATUS”, filed on Mar. 25, 2025, which is hereby incorporated by reference in its entirety.

### TECHNICAL FIELD

The present disclosure relates to the technical field of display, and in particular, to a display panel and a display apparatus.

### BACKGROUND

With the development of display technology, users are demanding higher display quality.

A display apparatus usually emits light by means of current drive when operating, so the characteristics of the driver elements will affect the display gray scale brightness.

### SUMMARY

The present disclosure provides a display panel and a display apparatus.

In an aspect, the present disclosure provides a display panel. The display panel includes pixel circuits arranged in an array, a first driving circuit, and a second driving circuit. Each of the plurality of pixel circuits includes a driver transistor, a writing module, a coupling module, a compensation module, and a light-emission element. The writing module is electrically connected to a gate of the driver transistor through the coupling module, the compensation module is electrically connected between the gate of the driver transistor and a drain of the driver transistor. The light-emission element is electrically connected to the driver transistor. A plurality of pixel rows of the plurality of pixel circuits form a pixel group. The first driving circuit is configured to sequentially control the compensation modules in the plurality of pixel rows in each of a plurality of the pixel groups to perform a threshold compensation on the driver transistors of the plurality of pixel circuits. The second driving circuit is configured to sequentially control the writing modules in each of the plurality of pixel rows to write a data signal to the gates of the driver transistors of the plurality of pixel circuits. The first driving circuit includes a plurality of first shift register units, and each of the plurality of first shift register units is electrically connected to the compensation modules in the plurality of pixel rows of pixel circuits in a same one of the plurality of the pixel groups. The second driving circuit includes a plurality of second shift register units, and each of the plurality of second shift register units is electrically connected to the writing modules in a corresponding one of the plurality of pixel rows.

In another aspect, the present disclosure provides a display apparatus. The display apparatus includes a display panel including: a plurality of pixel circuits arranged in an array, wherein each of the plurality of pixel circuits comprises a driver transistor, a writing module, a coupling module, a compensation module, and a light-emission element, wherein the writing module is electrically connected to a gate of the driver transistor through the coupling module, the compensation module is electrically connected between the gate of the driver transistor and a drain of the driver transistor, the light-emission element is electrically connected to the driver transistor, and a plurality of pixel rows of the plurality of pixel circuits form a pixel group; and a first driving circuit and a second driving circuit, wherein the first driving circuit is configured to sequentially control the compensation modules in the plurality of pixel rows in each of the pixel groups to perform a threshold compensation on the driver transistors of the plurality of pixel circuits, the second driving circuit is configured to sequentially control the writing modules in each of the plurality of pixel rows to write a data signal to the gates of the driver transistors of the plurality of the pixel circuits, the first driving circuit comprises a plurality of first shift register units, each of the plurality of first shift register units is electrically connected to the compensation modules in the plurality of pixel rows of the pixel circuits in a same one of the plurality of the pixel groups, and the second driving circuit comprises a plurality of second shift register units, and each of the second shift register units is electrically connected to the writing modules in a corresponding one of the plurality of pixel rows.

It should be understood that the description in this section is not intended to identify key or important features of the embodiments of the present disclosure, nor intended to limit the scope of the present disclosure. Other features of the present disclosure will be easily understood with the following specification.

### BRIEF DESCRIPTION OF THE DRAWINGS

In order to more clearly illustrate the technical solutions of the embodiments of the present disclosure, the accompanying drawings used in the embodiments of the present disclosure will be briefly described below. Obviously, the drawings described below are only some embodiments of the present disclosure, and based on these drawings, those skilled in the art can obtain other drawings without creative efforts.

FIG. 1 is a schematic diagram of a circuit configuration of a pixel circuit in the related art;

FIG. 2 is a schematic diagram of a timing sequence of a pixel circuit in the related art;

FIG. 3 is a top structural view of a display panel provided in some embodiments of the present disclosure;

FIG. 4 is a schematic diagram of a circuit configuration of a pixel circuit provided in some embodiments of the present disclosure;

FIG. 5 is a schematic diagram of a timing sequence of a pixel group provided in some embodiments of the present disclosure;

FIG. 6 is a schematic diagram of a circuit configuration of another pixel circuit provided in some embodiments of the present disclosure;

FIG. 7 is a top structural view of another display panel provided in some embodiments of the present disclosure;

FIG. 8 is a schematic diagram of a timing sequence of another pixel group provided in some embodiments of the present disclosure;

FIG. 9 is a schematic diagram of a timing sequence of another pixel group provided in some embodiments of the present disclosure;

FIG. 10 is a schematic diagram of another pixel circuit provided in some embodiments of the present disclosure;

FIG. 11 is a top structural view of another display panel provided in some embodiments of the present disclosure;

FIG. 12 is a schematic diagram of a timing sequence of another pixel group provided in some embodiments of the present disclosure;

FIG. 13 is a partial top view of a display panel provided in some embodiments of the present disclosure;

FIG. 14 is a top structural view of another display panel provided in some embodiments of the present disclosure;

FIG. 15 is a schematic diagram of a timing sequence of another pixel group provided in some embodiments of the present disclosure;

FIG. 16 is a partial top view of another display panel provided in some embodiments of the present disclosure;

FIG. 17 is a schematic diagram of a timing sequence of another pixel group provided in some embodiments of the present disclosure;

FIG. 18 is a partial top view of another display panel provided in some embodiments of the present disclosure;

FIG. 19 is a schematic diagram of another pixel circuit provided in some embodiments of the present disclosure;

FIG. 20 is a schematic diagram of another pixel circuit provided in some embodiments of the present disclosure;

FIG. 21 is a top structural view of another display panel provided in some embodiments of the present disclosure;

FIG. 22 is a schematic diagram of a timing sequence of another pixel group provided in some embodiments of the present disclosure;

FIG. 23 is a partial top view of another display panel provided in some embodiments of the present disclosure;

FIG. 24 is a top structural view of another display panel provided in some embodiments of the present disclosure;

FIG. 25 is a schematic diagram of a timing sequence of another pixel group provided in some embodiments of the present disclosure;

FIG. 26 is a partial top view of another display panel provided in some embodiments of the present disclosure;

FIG. 27 is a schematic diagram of a timing sequence of another pixel group provided in some embodiments of the present disclosure;

FIG. 28 is a partial top view of another display panel provided in some embodiments of the present disclosure;

FIG. 29 is a schematic diagram of a timing sequence of another pixel group provided in some embodiments of the present disclosure; and

FIG. 30 is a schematic structural diagram of a display apparatus provided in some embodiments of the present disclosure.

### DETAILED DESCRIPTION

In order to enable those skilled in the art to better understand the embodiments of the present disclosure, the embodiments of the present disclosure will be described clearly and completely in the following in conjunction with the accompanying drawings in the embodiments of the present disclosure, and it is obvious that the described embodiments are only some embodiments of the present disclosure and not all of the embodiments. Based on the embodiments in the present disclosure, all other embodiments obtained by those skilled in the art without creative efforts shall fall within the protection scope of the present disclosure.

It should be noted that the terms “first”, “second”, etc. in the specification and claims of the present disclosure and the accompanying drawings are configured to distinguish similar objects from each other, and are not configured to describe a particular order or sequence. It should be understood that the data used in this way can be interchanged in such a manner that the embodiments of the present disclosure described herein can be performed in an order other than those illustrated or described herein. In addition, the terms “comprising” and “having”, and any variations thereof, are intended to cover non-exclusive inclusion, for example, including a process, a method, a system, a product, or an apparatus including a series of steps or units need not be limited to those steps or units clearly listed, but can include those steps or units that are not clearly listed, but can include those steps or units that are not clearly presented or that are inherent to those the process, the method, the product, or the device.

FIG. 1 is a schematic diagram of a circuit configuration of a pixel circuit in the related art. Referring to FIG. 1, a pixel circuit PX′ includes a driver transistor M3′, a light-emission element LED′, an initialization transistor M5′, a compensation transistor M4′, a writing transistor M2′, a first light-emission control transistor M1′, a second light-emission control transistor M6′, a reset transistor M7′, and a storage capacitor Cst.

The initialization transistor M5′ includes a first electrode configured to receive a reset signal Vref′, a second electrode electrically connected to a gate of the driver transistor M3′ at a first node N1′, and a gate configured to receive a first scanning signal Scan1′. The writing transistor M2′ includes a first electrode configured to receive a data signal Data′, a second electrode electrically connected to a first electrode of the driver transistor M3′ at a second node N2′, and a gate configured to receive a second scanning signal Scan2′. The compensation transistor M4′ includes a first electrode electrically connected to a second electrode of the driver transistor M3′ at a third node N3′, and a second electrode electrically connected to the gate of the driver transistor M3′ at the first node N1′. The first light-emission control transistor M1′ includes a first electrode configured to receive a first power supply signal PVDD′, a second electrode electrically connected to the second node N2′, and a gate configured to receive a light-emission control signal Emit′. The second light-emission control transistor M6′ includes a first electrode electrically connected to the third node N3′, a second electrode electrically connected to a fourth node N4′ electrically connected to an anode of the light-emission element LED′, and a gate configured to receive the light-emission control signal Emit′. The light-emission element LED′ includes a cathode configured to receive a second power supply signal PVEE. The storage capacitor Cst includes a first electrode plate configured to receive the first power supply signal PVDD, and a second electrode plate electrically connected to the first node N1′.

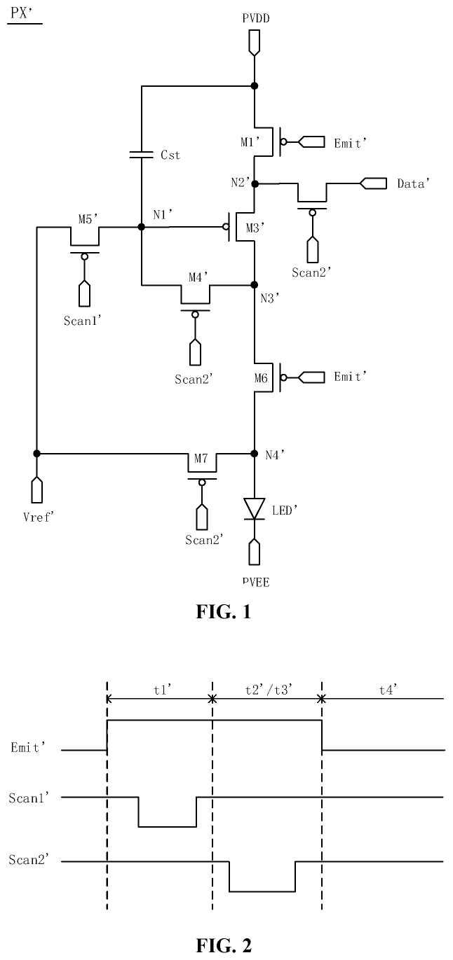

FIG. 2 is a schematic diagram of a timing sequence of a pixel circuit in the related art. The driving timing sequence in FIG. 2 corresponds to the pixel circuit in FIG. 1. Referring to FIG. 1 and FIG. 2, the pixel circuit PX′ includes an initialization phase t1′, a compensation phase t2′, a writing phase t3′, and a light-emission phase t4′. When the transistors in the pixel circuit PX′ are all P-type transistors, a low level is an enable level, and a high level is a disable level.

During an initialization phase t1′, the first scanning signal Scan1′ jumps to an enable level, the initialization transistor M5′ is turned on, and the reset signal Vref′ with a low potential is written to the first node N1′ through the initialization transistor M5′ to initialize the first node N1′ and to control the driver transistor M3′ to be turned on. The compensation phase t2′ and the writing phase t3′ overlap. During the compensation phase t2′ and the writing phase t3′, the second scanning signal Scan2′ jumps to an enable level, the writing transistor M2′ and the compensation transistor M4′ are turned on, and the data signal Data′ can be transmitted to the first node N1 through the writing transistor M2′, the driver transistor M3′, and the compensation transistor M4′, and during this process, a potential at the first node N1′ is continuously pulled up until the driver transistor M3′ reaches a critical state of an off-state (for the driver transistor M3′, Vgs=VN1′−VN2′=Vth), the data signal Data′ stops being transmitted to the first node N1′, and a compensated data signal Data′ is written to the first node N1′ whose potential VN1′ at this time is equal to (Vdata′+Vth). During the light-emission phase t4′, the light-emission control signal Emit′ jumps to an enable level, the first light-emission control transistor M1′ and the second light-emission control transistor M2′ are turned on, a potential VN2′ at the second node is equal to PVDD, for the driver transistor M3′, Vgs=VN1′−VN2′=Vdata′+Vth−PVDD<Vth, the driver transistor M3′ is turned on, and a driving current Id′=B′×[Vgs−Vth]²=B′×[Vdata′−PVDD]², where B′=(1/2)×μ×Cₒₓ×(W/L), μ is an electron mobility of the driver transistor M3′, Cₒₓ is a channel capacitance per unit area in the driver transistor M3′, and W/L is a channel width/length ratio of the driver transistor M3′. In this case, a magnitude of the driving current Id′ is related to Vdata′ and independent of Vth.

However, with the development of high resolution and high refresh rate, it will continuously shorten a period when the second scanning signal Scan2′ is the enable level, and with the resolution of 2800×1260, for example, at the resolution of 120 Hz, a time 1H for each line is longer than 2.8 us and shorter than 3.0 us for each line, which is already barely able to meet the requirement for the minimum critical time during which the threshold voltage Vth is fully compensated to the driver transistor M3′. Continuing to take the resolution of 2800×1260 as an example, when the resolution is 240 Hz, the time 1H for each line is longer than 1.4 us and smaller than 1.5 us, which is far from satisfying the minimum critical time during which the threshold voltage Vth is fully compensated to the driver transistor M3′. Before the driver transistor M3′ reaches the critical state, the second scanning signal Scan2′ jumps to a disable level. As a result, the threshold voltage Vth of the driver transistor M3′ cannot be fully compensated to the first node N1′, and the magnitude of the driving current Id′ is interfered with Vth. At the same time, since the Vth of the driver transistor M3′ offsets due to a manufacturing process deviation, aging, or temperature change, inconsistent driving currents are output under a same data signal Data′, which will seriously reduce display uniformity.

Moreover, even if the gate of the writing transistor M2′ and the gate of the compensation transistor M4′ are set to receive different scanning signals so that the writing transistor M2′ and the compensation transistor M4′ are turned on in a time-division manner, a signal written to the first node N1′ at a later time may interfere a signal previously written to the first node N1′, interfering the driving current and thus reducing the display uniformity.

To solve the above technical problems, some embodiments of the present disclosure provide a display panel. The display panel includes multiple pixel circuits arranged in an array, a first driver circuit, and a second driver circuit. The pixel circuit includes a driver transistor, a writing module, a coupling module, a compensation module, and a light-emission element. The writing module is electrically connected to a gate of the driver transistor through the coupling module. The compensation module is electrically connected between the gate and a drain of the driver transistor. The light-emission element is electrically connected to the driver transistor. Multiple rows of the pixel circuits form a pixel group. The first driver circuit is configured to sequentially control the compensation modules in the multiple rows of the pixel circuits in the pixel group to perform threshold compensation on the driver transistors of the multiple rows of the pixel circuits in the pixel group. The second driver circuit is configured to sequentially control the writing modules in each row of the pixel circuits to write a data signal to the gates of the driver transistors in the row of the pixel circuits. The first driver circuit includes multiple first shift register units, and the first shift register unit is electrically connected to the compensation modules in the multiple rows of the pixel circuits in a same pixel group. The second driving circuit includes multiple second shift register units, and the second shift register unit is electrically connected to the writing modules in one row of the pixel circuits.

With the above technical solution, the writing module is electrically connected to the driver transistor through the coupling module, so that the pixel circuits can independently perform a process of data writing and a process of the threshold compensation process, and the process of the threshold compensation is no longer interfered with the process of the data writing and no longer limited by a duration for the data writing. The first shift register unit of the first driving circuit is electrically connected to the compensation modules of multiple rows of the pixel circuits in a same pixel group, so that the multiple rows of the pixel circuits in the same pixel group can perform threshold compensation simultaneously. In this way, within a display period of a frame, the number of times that the first driving circuit of the display panel controls the pixel circuits to perform the threshold compensation can be different from the number of times that the second driving circuit controls the pixel circuits to perform the data writing, and a duration for the pixel circuit to perform the threshold compensation is not limited to a frequency at which the pixel circuit performs the data writing, which facilitates increasing a duration for the threshold compensation and increasing a charging rate during the threshold compensation. Even in a case with a high resolution and a high refresh rate, the pixel circuit realizes fast data writing while a fully compensation is performed on a threshold voltage, which facilities improving the uniformity of the display quality.

The above presents a core idea of the present disclosure. Based on the embodiments of the present disclosure, all other embodiments obtained by the person of ordinary skill in the art without creative efforts fall within the protection scope of the present disclosure. The technical solutions in the embodiments of the present disclosure will be clearly and completely described below in conjunction with the accompanying drawings in the embodiments of the present disclosure.

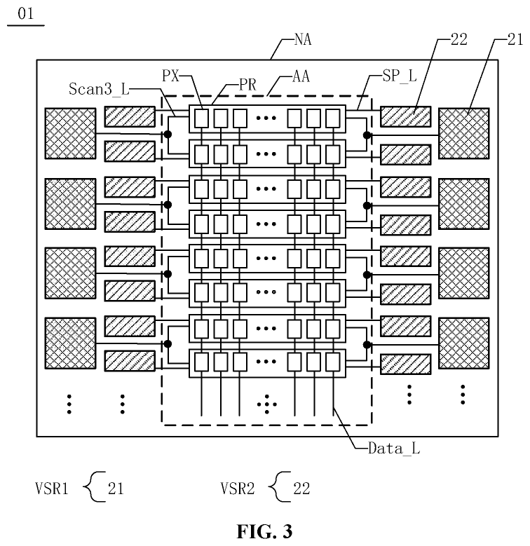

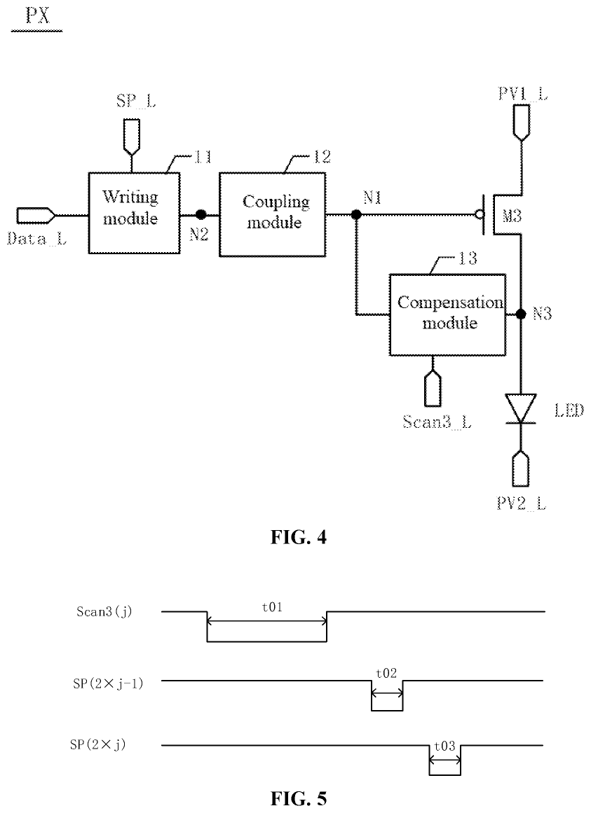

FIG. 3 is a top structural view of a display panel provided in some embodiments of the present disclosure, and FIG. 4 is a schematic diagram of a circuit configuration of a pixel circuit provided in some embodiments of the present disclosure. Referring to FIG. 3 and FIG. 4, the display panel 01 has a display region AA where multiple pixel circuits PX arranged in the array are provided, and the pixel circuit PX includes a driver transistor M3, a writing module 11, a coupling module 12, a compensation module 13, and a light-emission element LED. The writing module 11 is electrically connected to a gate of the driver transistor M3 at a first node N1 through the coupling module 12, and the writing module 11 is electrically connected to the coupling module 12 at a second node N2. The compensation module 13 is also electrically connected to the gate of the driver transistor M3 at the first node N1, and the compensation module 13 is electrically connected to a drain of the driver transistor M3 at a third node N3. The light-emission element LED is electrically connected to the driver transistor M3. The pixel circuits PX disposed in a same row form a pixel row PR, and multiple pixel rows PR can form a pixel group, that is, multiple rows of the pixel circuits PX can form a pixel group.

The display panel 01 also includes a first driving circuit VSR1 and a second driving circuit VSR2. The first driving circuit VSR1 includes multiple first shift register units 21, and the first shift register unit VSR1 is electrically connected to the compensation modules 13 in multiple rows of the pixel circuits PX in a same pixel group. The second driving circuit VSR2 includes multiple second shift register units 22, and the second shift register unit 22 is electrically connected to the writing modules 11 in one row of the pixel circuits PX. The first driving circuit VSR1 is configured to sequentially control the compensation modules 13 in the multiple rows of the pixel circuits PX in one pixel group to perform threshold compensation on the driver transistor M3 in the multiple rows of the pixel circuits PX in the pixel group, and the second driving circuit VSR2 is configured to sequentially control the writing modules 11 in one row of the pixel circuits PX to write a data signal data to the gates of the driver transistors M3 in the row of the pixel circuits PX.

Specifically, a first terminal of the writing module 11 can be electrically connected to a data voltage terminal (not shown in the figure) of the display panel 01 through a data line Data_L and is configured to receive a data signal Data from the data voltage terminal. When the writing module 11 is turned on, the data signal Data can be transmitted to the coupling module 12 through the writing module 11, and the coupling module 12 can couple the data signal Data to the first node N1 and write the data signal DATA to the gate of the driver transistor M3. A first terminal of the compensation module 13 can receive a signal at the third node N3. When the compensation module 13 is turned on, the signal at the third node N3 can be transmitted to the first node N1 through the compensation module 13, thereby compensating a threshold voltage Vth of the driver transistor M3 to the first node N1. In this way, when data are writing to the pixel circuit PX, the data signal Data can be superimposed with a signal at the first node N1 without interfering the threshold voltage Vth compensated to the first node N1. When the pixel circuit PX is performing the threshold compensation, the pixel circuit PX can not have to receive the data signal Data, and not limited to an on-state duration of the writing module 11, either, that is, the threshold compensation can be still performed on the pixel circuit PX when the writing module 11 is turned off.

Referring to FIG. 4, the writing modules 11 of the pixel circuits PX in one row can be connected to a same writing scanning line SP_L and receive a same writing scan signal SP. The writing modules 11 in different rows of the pixel circuits PX can be connected to different writing scanning lines SP_L, respectively, and receive different writing scan signals SP, respectively. One second shift register unit 22 is connected to one writing scanning line SP_L to provide a same writing scanning signal SP to the writing modules 11 in one row of the pixel circuits PX, and controls the writing modules 11 in the row of the pixel circuits PX to be turned on and turned off. The writing scan signals SP outputted by multiple second shift register units 22 can be sequentially transmitted stage-by-stage (not shown in the figures), thereby sequentially controlling multiple rows of the pixel circuits PX to write the data signal DATA to the gates of the driver transistors M3 in the multiple rows of the pixel circuits PX.

The compensation modules 13 in one row of the pixel circuits PX can be connected to a same compensation scanning line Scan3_L and receive a same compensation scanning signal Scan3. The compensation modules 13 in different rows of the pixel circuits PX in a same pixel group can be connected to different compensation scanning line Scan3_L but still receive a same compensation scanning signal Scan3. The compensation modules 13 of the pixel circuits PX in different pixel groups receive different compensation scanning signals Scan3. One first shift register unit 21 can be connected to multiple compensation scanning lines Scan3_L to provide a same compensation scanning signal Scan3 to the compensation modules 13 in multiple rows of the pixel circuits PX in a same pixel group, and to control the compensation modules 13 in this pixel group to be turned on or turned off. The compensation scanning signals Scan3 output by multiple first shift register units 21 can be sequentially transmitted stage-by-stage (not shown in the figures), thereby sequentially controlling the compensation modules 13 in the multiple rows of the pixel circuit PX in each pixel group to perform threshold compensation on the driver transistors M3 in the pixel group.

The row number of the multiple rows of the pixel circuits PX in the pixel group can be an integer greater than or equal to 2. Within a display period of a frame, the number of the compensation scanning signals Scan3 output by the first driving circuit VSR1 and times that the first driving circuit VSR1 outputs the compensation scanning signal Scan3 are smaller than the number of the writing scanning signals SP output by the second driving circuit VSR2 and times that the second driving circuit VSR2 outputs the writing scanning signal SP, respectively, and a pulse width of an effective pulse of the compensation scanning signal Scan3 can be greater than a pulse width of an effective pulse of the writing scanning signal SP such that a duration for the pixel circuit PX to perform the threshold compensation is longer than a duration for the pixel circuit PX to perform the data writing.

In some optional embodiments, when the resolution of the display panel 01 is increased, the total row number of the rows of the pixel circuits PX increases, and the number of the writing scanning signals SP output by the second driving circuit VSR2 and the times that the second driving circuit VSR2 outputs the writing scanning signal SP are increased within a display period of a frame, that is, the pulse width of the effective pulse of the writing scanning signal SP decreases, and the duration for the pixel circuit PX to perform the data writing is shortened. The row number of the rows of the pixel circuits PX in the pixel group can be increased so that the number of the compensation scanning signals Scan3 output by the first driving circuit VSR1 and the times that the first driving circuit VSR1 outputs the compensation scanning signal Scan3 are constant or change slightly within a display period of a frame, so that the pulse width of the effective pulse of the writing scanning signal SP keeps constant or changes slightly, thereby reducing the interfere of the high resolution on the duration for the pixel circuit PX to perform the threshold compensation.

In other optional embodiments, when the refresh frequency of the display panel 01 is increased, the frame duration is shortened, the pulse width of the effective pulse of the writing scanning signal SP is reduced, and the duration for the pixel circuit PX to perform the data writing is shortened. Also, the row number of the rows of the pixel circuits PX in the pixel group can be increased so that the pulse width of the effective pulse of the compensation scanning signal Scan3 keeps constant or changes slightly, so as to reduce the interfere of the high refresh rate on the duration for the pixel circuit PX to perform the threshold compensation, thereby keeping the duration for the pixel circuit PX to perform the threshold compensation constant or changing the duration for the pixel circuit PX to perform the threshold compensation slightly.

In addition, the display panel 01 can also be include multiple first power supply lines PV1_L and second power supply lines PV2_L (not shown in the figures) in the display region AA, and the display panel 01 can also include a first power supply voltage terminal and a second power supply voltage terminal (not shown in the figures). The first power supply voltage terminal is configured to provide a first power supply signal PV1 to the first power supply line PV1_L, and the first power supply line PV1_L can be electrically connected to the driver transistor M3 of the pixel circuit PX. The second power supply voltage terminal is configured to provide a second power supply signal PV2 to the second power supply line PV2_L, and the second power supply line PV2_L can be electrically connected to the light-emission element LED.

It should be noted that the figure only exemplarily shows that the driver transistor M3 is a P-type transistor. In this case, the driver transistor M3 is turned on when a condition, Vgs<Vth<0, is meet. In other optional embodiments, the driver transistor M3 can also be an N-type transistor. In this case, the driver transistor M3 is turned on when a condition, Vgs>Vth>0, is meet. Embodiments of the present disclosure do not limit the channel type of the driver transistor M3. To facilitate the description, the embodiments of the present disclosure exemplarily describe the technical solutions of the embodiments of the present disclosure taking the driver transistor M3 being the P-type transistor as an example.

It should also be noted that the figure only exemplarily shows that the multiple first shift register units 21 of the first driving circuit VSR1 and the multiple second shift register units 22 of the second shift register circuit VSR2 are located in a non-display region NA located at opposite sides of the display region AA. In other optional embodiments, the multiple first shift register units 21 of the first driving circuit VSR1 and the multiple second shift register units 22 of the second shift register circuit VSR2 can be located in the non-display region NA located at one side of the display region AA or can be located in the non-display region NA located at different sides of the display region AA, or at least one first shift register unit 21 of the multiple first shift register units 21 of the first driving circuit VSR1 and at least one second shift register unit 22 of the multiple second shift register units 22 of the second shift register circuit VSR2 can also be located in the display region AA. The embodiments of the present disclosure do not limit the positions of the first shift register units 21 and the positions of the second shift register units 22.

The operation principle of the pixel circuit provided in the embodiments of the present application is described below in connection with the time sequence.

Exemplarily, the pixel group includes two pixel rows PR, and the enable levels of the writing scanning signal SP and the compensation scanning signal Scan3 each are a low level, and the disable levels of the writing scanning signal SP and the compensation scanning signal Scan3 each are a high level. FIG. 5 is a schematic diagram of a timing sequence of a pixel group provided in some embodiments of the present disclosure, and a driving timing sequence in FIG. 5 corresponds to the pixel circuit in FIG. 4. It should be noted that the enable level referred to herein is a potential controlling a first terminal of each module to be conducted to a second terminal of the module, and the disable level is a potential controlling the first terminal of each terminal to be cut-off and disconnected from the second terminal of the module.

Referring to FIGS. 3-5, the compensation modules 13 in a (2×j−1)-th pixel row PR(2×j−1) in a j-th pixel group and the compensation modules 13 in a (2×j)-th pixel row PR(2×j) in the j-th pixel group can receive a j-th compensated scanning signal Scan3(j) outputted by a j-th first shift register unit 21(j), the writing modules 21 in the (2×j−1)-th pixel row PR(2×j−1) in the j-th pixel group can receive a (2×j−1)-th writing scanning signal SP(2×j−1) output from a (2×j-1)-th second shift register unit 22(2×j−1), and the writing modules 21 in the (2×j)-th pixel row PR(2×j) in the j-th pixel group can receive a (2×j)-th writing scanning signal SP(2×j) output from a (2×j)-th second shift register unit 22(2×j).

During an enabling period t01 of a j-th compensation scanning signal Scan3(j), the compensation modules 13 in both the (2×j−1)-th pixel row PR(2×j−1) and the (2×j)-th pixel row PR(2×j) are turned on, and the threshold compensation is performed on both the (2×j-1)-th row of the pixel circuits PX and the (2×j)-th row of the pixel circuit PX. During an enabling period t02 of the (2×j−1)-th writing scanning signal SP(2×j−1), the writing modules 11 in the (2×j−1)-th pixel row PR(2×j−1) are turned on, and the (2×j-1)-th row of the pixel circuits PX perform data writing. During an enabling period t03 of the (2×j)-th writing scanning signal SP(2×j), the writing modules 11 in the (2×j)-th pixel row PR(2×j) are turned on, and the (2×j)-th row of the pixel circuits PX performs data writing.

Still referring to FIGS. 3-5, the pixel circuits PX in a same column are connected to a same data line Data_L, and different data signals Data are need to be written to different rows of the pixel circuits PX, so that the period (t02) where the (2×j−1)-th row of the pixel circuits PX perform the data writing and the period (t03) where the (2×j)-th row of the pixel circuits PX of perform the data writing do not overlap. However, a period when the (2×j−1)-th row of the pixel circuits PX perform threshold compensation and a period when the (2×j)-th row of the pixel circuits PX perform threshold compensation can overlap, and these two period can be superimposed so that both the period when the (2×j−1)-th row of the pixel circuits PX perform the threshold compensation and the period when the (2×j)-th row of the pixel circuits PX perform the threshold compensation can be extended (e.g., t01). In this way, in a case with a high resolution and a high refresh rate, it can still be ensured that the pixel circuit PX can have enough time to perform the threshold compensation to completely compensate the threshold voltage Vth of the driver transistor M3 to the gate of the driver transistor M3, so as to prevent the magnitude of the driving current from being interfered with Vth, thereby preventing the display uniformity of the display panel 01 from being interfered.

It should be noted that the figures only exemplarily illustrate that one pixel group includes two pixel rows PR. In other embodiments, one pixel group can also include multiple pixel rows PR, such as three or four. The number of pixel rows PR in the pixel group is not limited in the embodiments of the present disclosure.

In the display panel provided in the embodiments of the present disclosure, the writing module is electrically connected to the driver transistor through the coupling module, so that the pixel circuits can independently perform a process of data writing and a process of the threshold compensation process, and the process of the threshold compensation is no longer interfered with the process of the data writing and no longer limited by a duration for the data writing. The first shift register unit of the first driving circuit is electrically connected to the compensation modules of multiple rows of the pixel circuits in a same pixel group, so that the multiple rows of the pixel circuits in the same pixel group can perform threshold compensation simultaneously. In this way, within a display period of a frame, the number of times that the first driving circuit of the display panel controls the pixel circuits to perform the threshold compensation can be different from the number of times that the second driving circuit controls the pixel circuits to perform the data writing, and a duration for the pixel circuit to perform the threshold compensation is not limited to a frequency at which the pixel circuit performs the data writing, which facilitates increasing a duration for the threshold compensation and increasing a charging rate during the threshold compensation. Even in a case with a high resolution and a high refresh rate, the pixel circuit realizes fast data writing while a fully compensation is performed on a threshold voltage, which facilities improving the uniformity of the display quality.

Optionally, referring to FIG. 4 and FIG. 5, in a same pixel circuit PX, the period when the pixel circuit PX performs the threshold compensation is prior to the period when the pixel circuit PX performs the data writing, and these two period do not overlap.

Specifically, during the period when the pixel circuit PX performs the threshold compensation, the compensation scanning signal Scan3 jumps to an enable level, the compensation module 13 is turned on, and the compensation module 13 can transmit the signal at the third node N3 to the first node N1 to change the signal at the first node N1. During the period when the pixel circuit PX performs the data writing, the writing scanning signal SP jumps to an enable level, the writing module 11 is turned on, and the writing module 11 can couple the data signal Data to the first node N1 to superimpose the data signal Data to the first node N1. With the configuration in which the period when the pixel circuit PX performs the threshold compensation is prior to the period when the pixel circuit PX performs the data writing, the threshold voltage of the driver transistor M3 to the first node N1 can first be compensated to the pixel circuit PX, and then the coupling module 13 superimposes the data signal Data to the first node N1, which facilitates completely compensating the threshold voltage Vth to the first node N1, and also facilitates accurately writing the data signal Data to the first node N1. In this way, it is avoided that the threshold compensation and the writing data are carried out simultaneously, which prevents accurate compensation of the threshold voltage Vth from being interfered. It is also avoided that the threshold compensation is performed after the data writing, which prevents the data signal Data superimposed on the first node N1 from being interfered, and thus avoid a poor display effect.

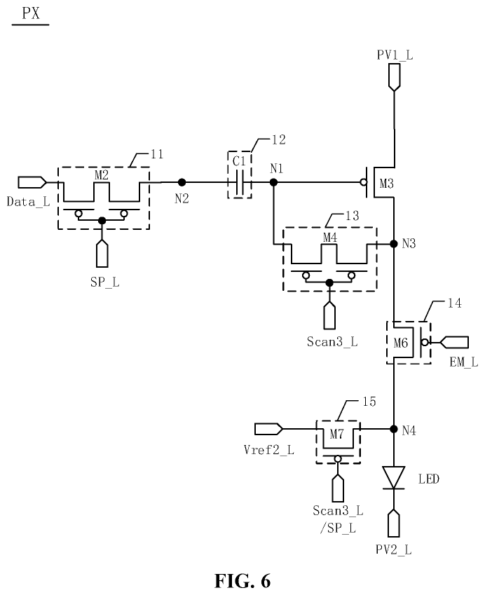

Optionally, FIG. 6 is a schematic diagram of a circuit configuration of another pixel circuit provided in some embodiments of the present disclosure. Referring to FIG. 3 and FIG. 6, the writing module 11 includes a writing transistor M2. The writing transistor M2 includes a first electrode configured to receive the data signal Data, a second electrode electrically connected to the first terminal of the coupling module 12 at the second node N2, and a gate electrically connected to the second shift register unit 22 through the writing scanning line SP_L. The compensation module 13 includes a compensation transistor M4, and the compensation transistor M4 includes a first electrode electrically connected to the drain of the driver transistor M3 at the third node N3, a second electrode electrically connected to the gate of the driver transistor M3 at the first node N, and a gate electrically connected to the first shift register unit 21 through the compensation scanning line Scan3_L.

Exemplarily, all the transistors in the pixel circuit 10 are P-type transistors, and active layers of all the transistors in the pixel circuit PX can be provided in a same layer, which reduces the preparation process and reduces the preparation cost. Enable levels of the gates of all the transistors are low levels, and gate signals of the different transistors can be shared by the different transistors when pulse widths of the enable levels are the same. In some optional embodiments, at least some transistors in the pixel circuit PX can be of a dual gate structure, which facilitates improving the stability and mobility of the transistors.

It should be noted that in other optional embodiments, the writing transistor M2 and/or the compensation transistor M4 can be an N-type transistor, and when the writing transistor M2 and/or the compensation transistor M4 is an N-type transistor, the active layer of the writing transistor M2 and/or the active layer of the compensation transistor M4 can include a metal-oxide material. When preparing the active layer of the writing transistor M2 and/or the active layer of the compensation transistor M4, a crystal structure is formed without crystallizing,, so that a defect density of the active layer is relatively small, and the active layer has a relatively high carrier mobility and a relatively low temperature sensitivity, which makes the writing transistor M2 and/or the compensation transistor M4 to be turned on quickly, thereby improving a charging speed and a charging rate in a case with a high resolution and a high refresh rate, and thus improving the display effect.

Optionally, the coupling module 12 includes a coupling capacitor C1 electrically connected between the first node N1 and the second node N2.

Specifically, the writing transistor M2 is electrically connected to the gate of the driver transistor M3 at the first node N1 through the coupling capacitor C1. On the one hand, with a fast charging and discharging characteristic of the coupling capacitor C1, a change of the data signal Data of the second electrode of the writing transistor M2 can be quickly transferred to the gate of the driver transistor M3, which reduces a signal delay and improves a response speed of the pixel circuit PX. On the other hand, the coupling capacitor C1 can isolate the DC signal and superimpose the data signal Data to the first node N1, avoiding level conflicts or signal coverage caused by direct connection and ensuring stable operation of the pixel circuit PX.

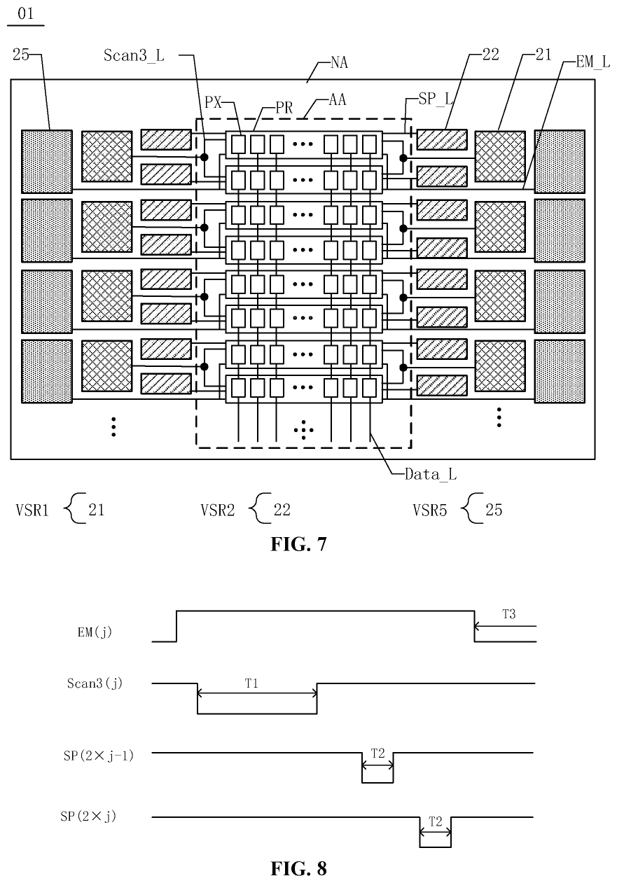

FIG. 7 is a top structural view of another display panel provided in some embodiments of the present disclosure. Referring to FIG. 6 and FIG. 7, the pixel circuit PX further includes a light-emission control module 14 electrically connected between the driver transistor M3 and the light-emission element LED. The display panel 01 further includes a fifth driving circuit VSR5, and the fifth driving circuit VSR is configured to sequentially turn on the light-emission control modules 14 in multiple rows of pixel circuits PX in the pixel group.

Specifically, the light-emission control modules 14 of the pixel circuits PX disposed in a same row can be connected to a same light-emission control line EM_L and configured to receive a same light-emission control signal EM. The light-emission control modules 14 of the pixel circuits PX disposed in a same pixel group and in different rows can be connected to different compensating scanning lines Scan3_L, but can still receive a same light-emission control signal EM. The light-emission control modules 14 of the pixel circuits PX disposed in different pixel groups receive different light-emission control signals EM. The fifth driving circuit VSR5 includes multiple fifth shift register units 25. One fifth shift register unit 25 is connected to multiple light-emission control signals EM to provide a same light-emission control signal EM to the light-emission control modules 14 in multiple rows of the pixel circuits PX in a same pixel group, and to control these light-emission control modules 14 to be turned on or turned off. The light-emission control signals EM output by multiple fifth shift register units 25 can be sequentially transferred stage-by-stage (not shown in the figures), so as to sequentially control the light-emission elements LED in the multiple rows of the pixel circuits PX in each pixel group to emit light to display an image.

Within a display period of a frame, the number of the light-emission control signal EM output by the fifth driving circuit VSR5 and times that the fifth driving circuit VSR5 outputs the light-emission control signal EM can be equal to the number of the compensation scanning signals Scan3 output by the first driving circuit VSR1 and the times that the first driving circuit VSR1 outputs the compensation scanning signal Scan3, respectively, both the number of the light-emission control signal EM output by the fifth driving circuit VSR5 and the number of the compensation scanning signals Scan3 output by the first driving circuit VSR1 are smaller than the number of the writing scanning signals SP output by the second driving circuit VSR2, and both the times that the fifth driving circuit VSR5 outputs the light-emission control signal EM and the times that the first driving circuit VSR1 outputs the compensation scanning signal Scan3 are smaller than the times that the second driving circuit VSR2 outputs the writing scanning signal SP. In this way, it is advantageous to reduce the number of the fifth shift register units 25 in the fifth driving circuit VSR5, simplifying the circuit arrangement, and reducing their occupied space, thereby realizing a thin and light display panel 01 and a narrow bezel.

It can be understood that the figure only exemplarily illustrates that the fifth shift register units 25 of the fifth driving circuit VSR5 are located in a non-display region NA located at two opposite sides of the display region AA. In other optional embodiments, the fifth shift register units 25 can be located in a non-display region NA located at a same side of the display region AA, or the fifth shift register unit 25 can also be located in the display region AA. The embodiments of the present disclosure does not specifically limit a location of the fifth shift register unit 25.

Exemplarily, the light-emission control module 14 includes a light-emission control transistor M6. The light-emission control transistor M6 includes a first electrode electrically connected to the driver transistor M3 at the third node N3, a second electrode electrically connected to the light-emission element LED at a fourth node N4, and a gate electrically connected to the fifth shift register unit 25 through the light-emission control line EM_L. The light-emission control transistor M6 can be a P-type transistor or an N-type transistor, which is not limited in the embodiments of the present disclosure. To facilitate description, the embodiments of the present disclosure all exemplarily illustrate the technical solutions of the embodiments of the present disclosure with the example where the transistors in the pixel circuit PX are all P-type transistors.

Optionally, with continued reference to FIG. 6 and FIG. 7, the pixel circuit PX includes a reset module 15 electrically connected to the light-emission element LED. In a same pixel circuit PX, the reset module 15 and the compensation module 13 are connected to a same first shift register unit 21, and/or, the reset module 15 and the writing module 11 are connected to a same second shift register unit 22.

Exemplarily, the reset module 15 includes a second reset transistor M7. The second reset transistor M7 includes a first electrode that can be electrically connected to a second reference voltage terminal (not shown in the figures) through a second reset line Vref2_L to receive a second reset signal Vref2, a second electrode electrically connected to the light-emission element LED at the fourth node N4, and a gate that can be electrically connected to the first shift register unit 21 through the compensation scanning line Scan3_L. The second reset transistor M7 and the compensation transistor M4 have a same channel type. Alternatively, the gate of the second reset transistor M7 can be electrically connected to the second shift register unit 22 through the writing scanning line SP_L, and the second reset transistor M7 and the writing transistor M2 have a same channel type. In a same pixel circuit PX, the gate of the second reset transistor M7 and the gate of the compensation transistor M4 can be connected to a same compensation scanning line Scan3_L, or the gate of the second reset transistor M7 and the gate of the writing transistor M2 are connected to a same writing scanning line SP_L. The second reset transistor M7 can be turned on when the light-emission control transistor M6 is turned off, and a second reference signal Vref2 of the second reference voltage terminal is transmitted to the fourth node N4 to reset the fourth node N4.

The description is continued with the example that the pixel group includes two pixel rows PR, the enable levels of the writing scanning signal SP, the compensation scanning signal Scan3, and the light-emission control signal EM are low levels, and the disable levels of the writing scanning signal SP, the compensation scanning signal Scan3, and the light-emission control signal EM are high levels. FIG. 8 is a schematic diagram of a timing sequence of another pixel group provided in some embodiments of the present disclosure, and a driving timing sequence in FIG. 8 corresponds to the pixel circuit in FIG. 6. Referring to FIGS. 6-8, within a display period of a frame, the pixel circuit PX includes a compensation phase T1, a writing phase T2, and a light-emission phase T3. During the compensation phase T1, the compensation scanning signal Scan3 is at an enable level, the writing scanning signal SP and the light-emission control signal EM each are at a disable level, the compensation transistor M4 are turned on, and the writing transistor M2 and the light-emission control transistor M6 are turned off. When light-emission is performed during a display period of a previous frame, Vgs=VN1−PV1<Vth<0 is satisfied. At the beginning of the compensation phase T1 of a current frame duration, the driver transistor M3 can continue to be turned on, and the first power supply signal PV1 can be transmitted to the first node N1 through the driver transistor M3 and the compensation transistor M4, pulling up a potential at the first node N1, and increasing the gate-source voltage Vgs of the driver transistor M3 continuously until Vgs=VN1−PV1=Vth (Vth<0) is satisfied. The driver transistor M3 is in a critical state between a turned on state and a turned on state, a current in the driver transistor M3 decreases to zero, the first power supply signal PV1 is no longer transmitted to the first node N1, and the potential at the first node N1 is stable. At this time, VN1=VN3=PV1+VTH (Vth<0) is satisfied, and the threshold voltage is compensated to the first node N1.

During the writing phase T2, the light-emission control signal EM continues to keep the disable level, the compensation scanning signal Scan3 jumps to a disable level, the writing scanning signal SP jumps to an enable level, the writing transistor M2 is turned on, and the compensation transistor M4 and the light-emission control transistor M6 are turned off. The data signal Data can be written to the second node N2, and a potential change amount ΔVN2 at the second node N2 can be coupled to the first node N1 through the coupling capacitor C1, so that ΔVN1=ΔVN2, VN1=PV1+VTH +ΔVN1=PV+VTH+ΔVN2<PV1+VTH (ΔVN2 <0, Vth<0), and Vgs=VN1−PV1=VTH+ΔVN1=VTH+ΔVN2<Vth<0, and the driver transistor M3 is fully turned on.

During the light-emission phase T3, the compensation scanning signal Scan3 continues to keep the disable level, the writing scanning signal SP jumps to a disable level, the light-emission control signal EM jumps to an enable level, the light-emission control transistor M6 are turned on, and the writing transistor M2 and the compensation transistor M4 are turned off. The driver transistor M3 generates a driving current Id according to its gate signal (PV1+VTH+ΔVN2) and the first power supply signal PV1, and the driving current Id=B×(Vgs−Vth)²=B×ΔVN1²=B×ΔVN2², and the light-emission element LED can display with a corresponding brightness according to the driving current Id. A display grayscale of the pixel circuit PX can be controlled by controlling brightness and a light-emission duration of the light-emission element LED. B=(1/2)×μ×Cₒₓ×(W/L), where μis an electron mobility of the driver transistor M3, Cₒₓ is a channel capacitance per unit area of the driver transistor M3, and W/L is a channel width to length ratio of the driver transistor M3.

ΔVN2 is related to only the data signal Data written during the writing phase T2 and the potential at the second node N2 before the writing phase T2, and is not related to the threshold voltage Vth of the driver transistor M3, and the device difference of the driver transistor M3 does not interfere the magnitude of the driving current Id nor the display uniformity.

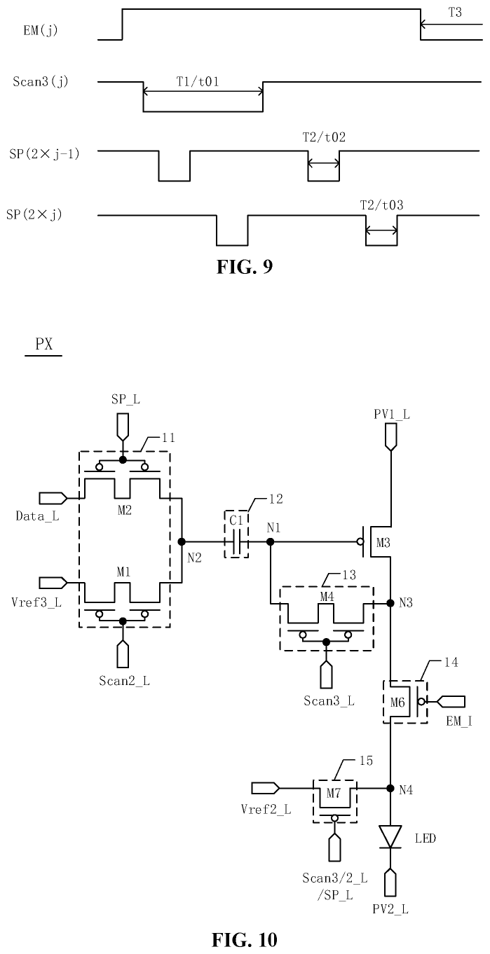

In some optional embodiments, a potential at the second node N2 before the writing phase T2 can be the data signal Data written during a display period of a previous frame, or can be the data signal Data written into a pixel circuit PX located in a same column and in a prior row. As shown in FIG. 9, within a display period of a frame, the writing scanning signal SP can also jump to the enable level before the writing phase T2. When written to a pixel circuit PX in a column and in a prior row (i.e., (i−2)-th row), the data signal Data can also be written to another pixel circuit PX in a same column and a current row (i-th row) and serves as the potential at the second node N2 before the writing phase T2. However, the potential at the second node N2 before the writing phase T2 is not limited to this.

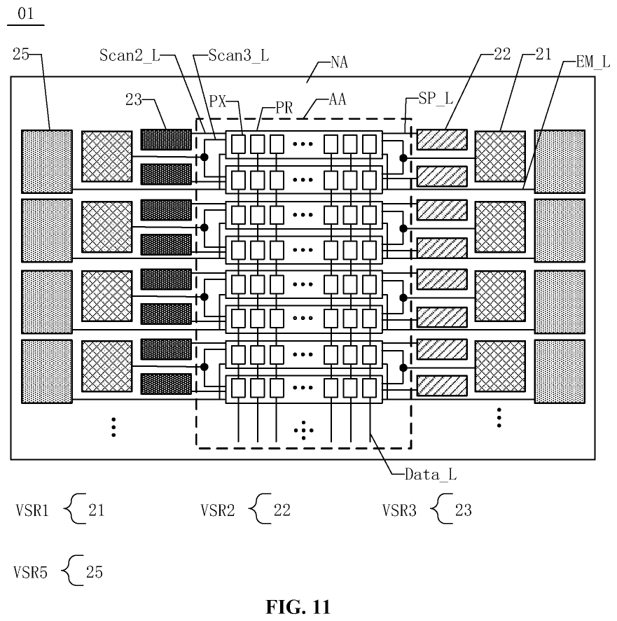

FIG. 10 is a schematic diagram of another pixel circuit provided in some embodiments of the present disclosure, and FIG. 11 is a top structural view of another display panel provided in some embodiments of the present disclosure. Optionally, referring to FIG. 10 and FIG. 11, the writing module 11 further includes a first reset transistor M1. The first reset transistor M1 includes a first electrode configured to receive a first reset signal Vref3, and a second electrode electrically connected to the second node N2. The display panel 01 further includes a third driving circuit VSR3 including multiple third shift register units 23, the third shift register units 23 each are electrically connected to a gate of the first reset transistor M1 and are configured to sequentially control the first reset transistors M1 in a row of the pixel circuits to reset the second node N2. In one pixel circuit PX, the gate of the second reset transistor M7 of the reset module 15 and a gate of the first reset transistor M1 of the writing module 11 can be connected to a same third shift register unit 23a.

Exemplarily, the first electrode of the first reset transistor M1 can be electrically connected to a third reference voltage terminal (not shown in the figures) through the third reset line Vref3_L to receive the first reset signal Vref3, and the gate of the first reset transistor M1 can be electrically connected to the third shift register unit 23 through the reset scanning line Scan2_L to receive the reset scanning signal Scan2. In some optional embodiments, the third reference voltage terminal can multiplex the second reference voltage terminal, and the third reset line Vref3_L can multiplex the second reset line Vref2_L.

Within a display period of a frame, the first reset transistor M1 can be turned on before the writing transistor M2 is turned on, so that the second node N2 is reset to clear an electrical signal at the second node N2 remaining in a display period of a previous frame. In this way, it is possible to make the potential change amount ΔVN2 at the second node N2 satisfy ΔVN2=Data−Vref3 after the data signal Data is written to the pixel circuit PX, and when the pixel circuit PX emits light to display an image, the driving current Id=B×(Vgs−Vth)²=B×ΔVN1²=B×ΔVN2²=B×(Data−Vref3)², and B=(1/2)×μ×Cₒₓ×(W/L).

On the one hand, the potentials at the second nodes N2 in all the pixel circuits PX can be uniformly set to Vref3 before the writing phase T2, which facilitates simplifying the control to the driving current, and also facilitates the uniformity of the pixel circuits PX in the display panel 01, thereby improving the display uniformity of the display panel 01. On the other hand, the first reset signal Vref3 can be set to be a positive electrical signal, and the data signal Data can be an electrical signal with a small absolute value, so that the data signal Data on the data line Data_L varies around 0 V, which facilitates reducing power consumption, increasing a charging rate, and realizing a high resolution and a high refresh rate.

On the basis of the above embodiments, in a same pixel circuit PX, a period when the pixel circuit PX resets the second node N2 overlaps the period when the pixel circuit PX performs the threshold compensation.

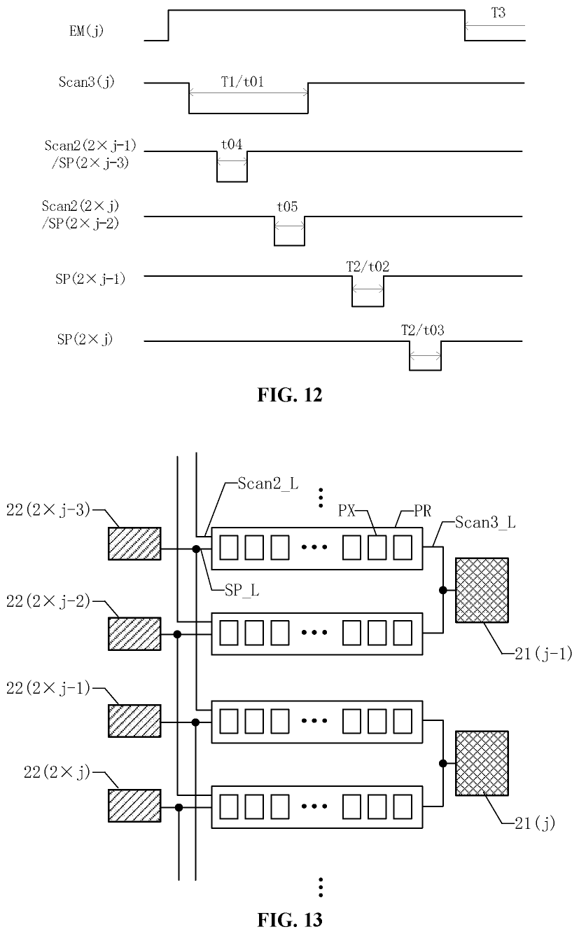

Exemplarily, the following continues to describe with an example where the pixel group includes two pixel rows PR, the enable level is a low level, and the disable level is a high level. FIG. 12 is a schematic diagram of a timing sequence of another pixel group provided in some embodiments of the present disclosure, and a driving timing in FIG. 12 corresponds to the pixel circuit in FIG. 10. Referring to FIGS. 10-12, the gate of the first reset transistor M1 in a (2×j−1)-th pixel row PR(2×j−1) can receive a (2×j−1)-th reset scanning signal Scan2(2×j−1) output from an (2×j−1)-th third shift register unit 23(2×j−1), and the gate of the first reset transistor M1 in a (2×j)-th pixel row (2×j) can receive a (2×j)-th reset scanning signal Scan2(2×j) output from a (2×j)-th third shift register unit.

During an enabling period t04 of the (2×j−1)-th reset scanning signal Scan2(2×j−1), the first reset transistor M1 in a (2×j−1)-th pixel row PR(2×j−1) is turned on, and the potential at the second node N2 in the (2×j−1)-th row of the pixel circuits is reset to Vref3; and at the same time, the compensation transistor M4 in the (2×j−1)-th pixel row PR(2×j−1) is turned on, and the potential at the second node N2 in the (2×j-1)-th row of the pixel circuits PX can be compensated to (PV1+VTH). During an enabling period t05 of the (2×j)-th reset scanning signal Scan2(2×j), the first reset transistor M1 in a (2×j)-th pixel row PR(2×j) is turned on, and the potential at the second node N2 in the pixel circuit PX in the (2×j)-th row is reset to Vref3; and at the same time, the compensation transistor M4 in the (2×j)-th row is also turned on, and the potential of the second node N2 in the (2×j)-th row of the pixel circuit PX is compensated to (PV1+VTH).

In this way, the period when the second node N2 is reset and the period when the first node N1 is compensated overlap, ensuring that the potential of the first node N1 after the threshold compensation is not interfered with a potential change at the second node N2, as well as ensuring that a potential at the second node N2 after being reset is not interfered with the potential change at the first node N1, which facilitates an accurate compensation to the potential at the first node N1 and an accurate reset to the potential at the first node N1.

In some optional embodiments, the third shift register unit 23 is electrically connected to the gates of the first reset transistors M1 in a row of the pixel circuits PX, the third shift register unit 23 multiplexes the second shift register unit 22, and the gates of the first reset transistors M1 in an i-th row of the pixel circuits PX and the gates of the writing transistors M2 in an (i-e)-th row of the pixel circuits PX are connected to a same second shift register unit 22, where i and e are integers and i>e≥2.

Exemplarily, the description is continued with the example where the pixel group includes two pixel rows PR, the enable level is the low level, and the disable level is the high level. FIG. 13 is a partial top view of another display panel provided in some embodiments of the present disclosure. Referring to FIG. 10, FIG. 12, and FIG. 13, the gates of the first reset transistors M1 in a (2×j−1)-th pixel row PR(2×j−1) and the gates of the writing transistors M2 in a (2×j−3)-th pixel row PR(2×j−3) can be electrically connected to a (2×j−3)-th second shift register unit 22(2×j−3), and the gates of the first reset transistors M1 in the (2×j−1)-th pixel row PR(2×j−1) can receive a (2×j−3)-th writing scanning signal SP(2×j−3) output from the (2×j−3)-th second shift register unit 22(2×j−3) as a reset scanning signal Scan2(2×j−1).

The gates of the first reset transistors M1 in a (2×j)-th pixel row PR(2×j) and the gates of the writing transistors M2 in a (2×j−2)-th pixel row PR(2×j−2) can be electrically connected to a (2×j−2)-th second shift register unit 22(2×j−2), and the gates of the first reset transistors M1 in a (2×j)-th pixel row PR(2×j) can receive a (2×j−2)-th writing scanning signal SP(2×j−2) output from the (2×j−2)-th second shift register unit 22(2×j−2) as the reset scanning signal Scan2(2×j). In this way, the number of the driving circuits can be reduced by multiplexing the shift register unit and multiplexing the signal, which facilitates realizing the narrow bezel of the display panel 01, and also facilitates the circuit arrangement and simplifying a layout difficulty.

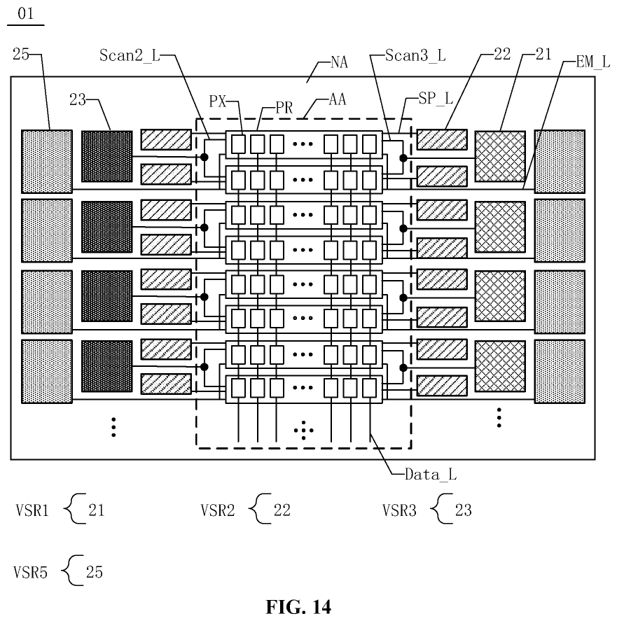

FIG. 14 is a top structural view of another display panel provided in some embodiments of the present disclosure. In some optional embodiments, referring to FIG. 10 and FIG. 14, the third shift register unit 23 is electrically connected to the gates of the first reset transistors M1 in multiple rows of the pixel circuits PX in a same pixel group.

Specifically, the gates of the first reset transistors M1 in an (2×j−1)-th pixel row PR(2×j−1) and the gates of the first reset transistors M1 in the (2×j)-th pixel row PR(2×j) can receive a j-th reset scanning signal Scan 2(j) output from a j-th third shift register unit 23(j). Within a display period of a frame, the number of the reset scanning signals Scan2 output by the third driving circuit VSR3 and times that the third driving circuit VSR3 outputs the reset scanning signal Scan2 can be equal to the number of the compensation scanning signals Scan3 output by the first driving circuit VSR1 and the times that the first driving circuit VSR1 outputs the compensation scanning signal Scan3, respectively, both the number of the reset scanning signals Scan2 output by the third driving circuit VSR3 and the number of the compensation scanning signals Scan3 output by the first driving circuit VSR1 are smaller than the number of the writing scanning signals SP output by the second driving circuit VSR2, and both the times that the third driving circuit VSR3 outputs the reset scanning signal Scan2 and the times that the first driving circuit VSR1 outputs the compensation scanning signal Scan3 are smaller than the times that the second driving circuit VSR2 outputs the writing scanning signal SP. In this way, it facilitates reducing the number of the third shift register units 23 in the third driving circuit VSR3, simplifying the circuit arrangement, and reducing their occupied space, thereby realizing the thin and light display panel 01 and the narrow bezel.

On the basis of the above embodiments, the third shift register unit 23 can multiplex the second shift register unit 22, the gates of the first reset transistors M1 in the pixel circuits PX in a j-th pixel group and the gates of the writing transistors M2 in a ((j−1)×k−p)-th row of the pixel circuits PX are connected to a same second shift register unit 22, where j, k, and p are integers, j>1, k is the row number of the rows of the pixel circuit in the pixel group, and p≥0.

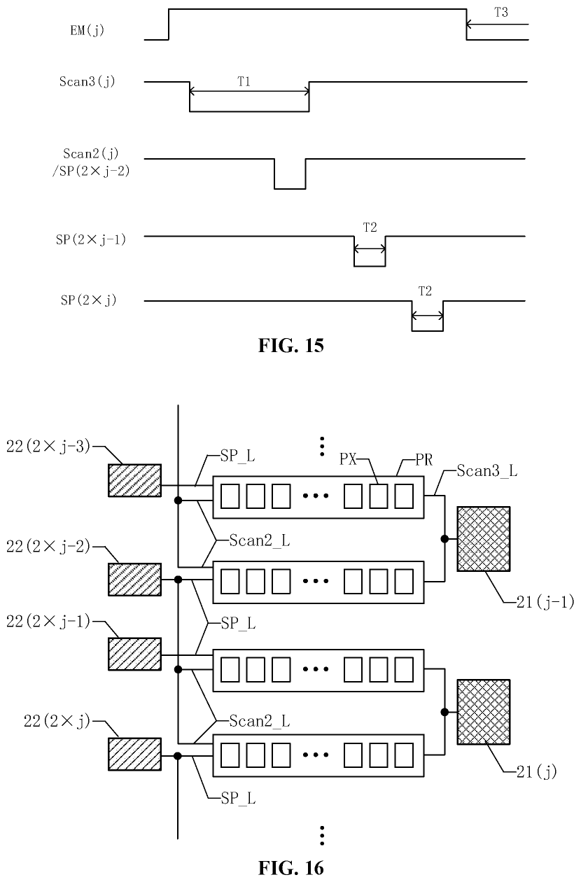

Exemplarily, the description is continued with the example where the pixel group includes two pixel rows PR, the enable level is the low level, and the disable level is the high level. FIG. 15 is a schematic diagram of a timing sequence of another pixel group provided in some embodiments of the present disclosure. A driving timing sequence in FIG. 15 corresponds to the pixel circuit in FIG. 10. FIG. 16 is a partial top view of another display panel provided in some embodiments of the present disclosure. Referring to FIG. 10, FIG. 15, and FIG. 16, the gates of the first reset transistors M1 in the (2×j−1)-th row, the gates of the first reset transistors M1 in the (2×j)-th row, and the gates of the writing transistors M2 in the (2×j−2)-th row can all be electrically connected to the (2×j−2)-th second shift register unit 22(2×j−2), and the gates of the first reset transistors M1 in the (2×j−1)-th row and the gates of the first reset transistors M1 in the (2×j)-th row can receive the (2×j−2)-th writing scanning signal SP (2×j−2) output from the (2×j−2)-th second shift register unit 22(2×j−2) as the reset scanning signal Scan2(j).

In other optional embodiments, the gates of the first reset transistors M1 in the (2×j−1)-th row and the gates of the first reset transistors M1 in the (2×j)-th row can also be electrically connected to the (2×j−3)-th second shift register unit 22(2×j−3) or a (2×j−4)-th second shift register unit 22(2×j−4), and are configured to receive the writing scanning signal SP (2×j−3) or a writing scanning signal SP(2×j−4) as the reset scanning signal Scan2(j), so as to satisfy that within a display period of a frame, the period when the pixel circuit PX resets the second node N2 in a same pixel circuit PX overlaps the period when this pixel circuit PX performs the threshold compensation.

In this way, the number of the driving circuits can be reduced through the shift register unit multiplexing and the signal multiplexing, which facilitates realizing the narrow bezel of the display panel 01, and also facilitates the circuit arrangement and simplifying the layout difficulty. At the same time, in a same pixel circuit PX, the compensation scanning signal Scan3 and the reset scanning signal Scan2 whose enabling level periods overlap are connected to different shift register units, which facilitates reducing a load on the compensation scanning line Scan3_L, reducing a signal delay of the compensation scanning signal Scan3, and increasing a charging duration of the threshold compensation phase, thereby enabling the pixel circuit PX to completely compensate the threshold voltage Vth of the driver transistor M3 to the first node N1 to improve the display uniformity of the display panel 01.

Based on the above embodiments, the third shift register unit 23 can also multiplex the first shift register unit 21, and in a same pixel circuit PX, the gate of the first reset transistor M1 and the gate of the compensation transistor M4 are connected to a same first shift register unit 21.

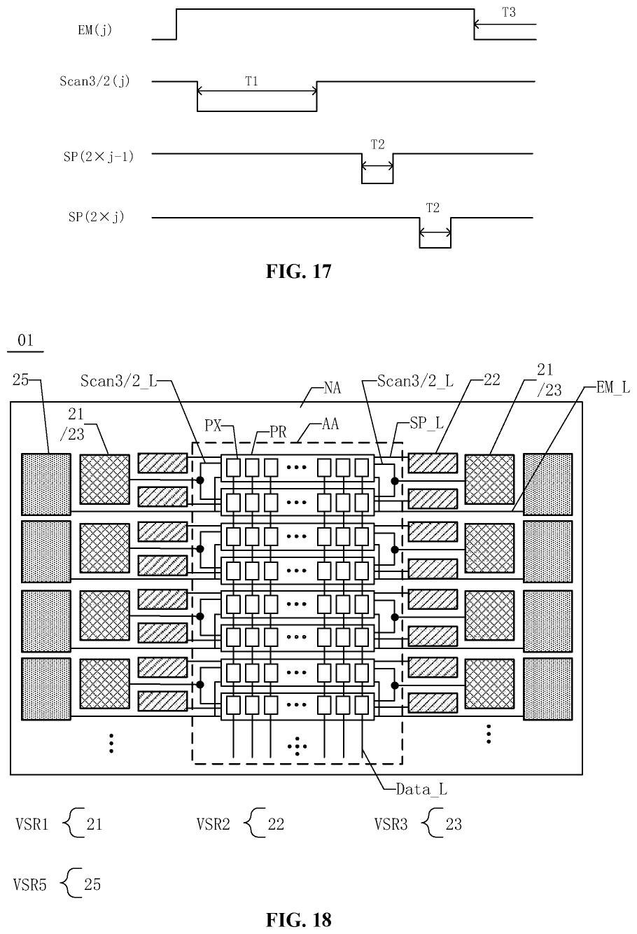

Exemplarily, the description is continued with the example where a pixel group includes two pixel rows PR, the enable level is the low level, and the disable level is the high level. FIG. 17 is a schematic diagram of a timing sequence of another pixel group provided in some embodiments of the present disclosure, and a driving timing sequence in FIG. 17 corresponds to the pixel circuit in FIG. 10. FIG. 18 is a partial top view of another display panel provided in some embodiments of the present disclosure. Referring to FIG. 10, FIG. 17, and FIG. 18, the gates of the first reset transistors M1 in the (2×j−1)-th row and the gates of the first reset transistors M1 in the (2×j)-th row can be electrically connected to the j-th first shift register unit 21(j), and the gates of the first reset transistors M1 in the (2×j−1)-th row and the gates of the first reset transistors M1 in the (2×j)-th row can receive the j-th compensation scanning signal Scan3(j) output by the j-th first shift register unit 21(j) as a reset scanning signal Scan2(j). The gates of the first reset transistors M1 and the gates of the compensation transistors M4 that are located in a same row can be connected to a same compensation scanning line Scan3_L, which facilitates reducing the number of jumped signal lines, simplifying the line layout, and reducing a design difficulty.

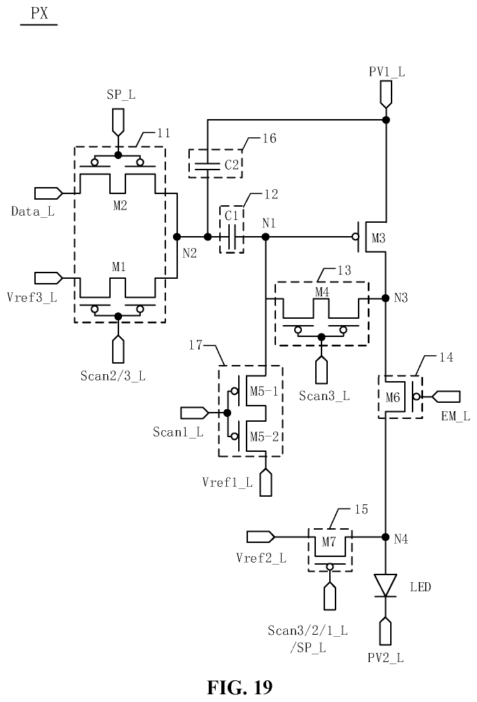

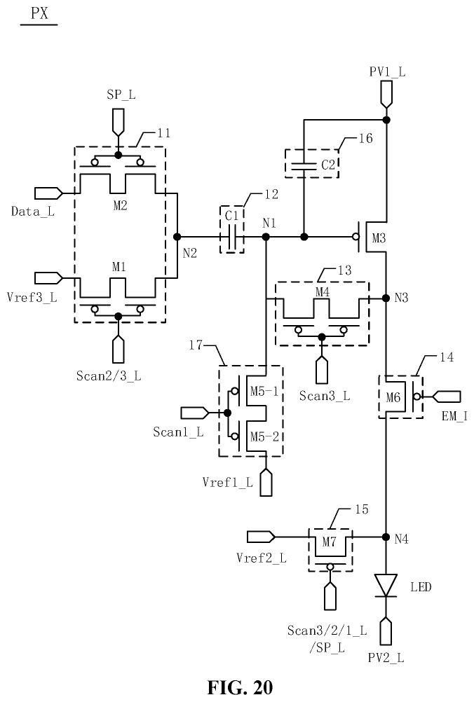

FIG. 19 is a schematic diagram of another pixel circuit provided in some embodiments of the present disclosure, and FIG. 20 is a schematic diagram of another pixel circuit provided in some embodiments of the present disclosure. Optionally, referring to FIG. 19 and FIG. 20, the pixel circuit PX further includes a storage module 16 including a storage capacitance C2. The storage capacitance C2 include a first electrode plate electrically connected to a first power supply terminal, and a second electrode plate electrically connected to a first electrode plate of the coupling capacitor C1 at the second node N2 or electrically connected to a second electrode plate of the coupling capacitor C1 at the first node N1.

Exemplarily, referring to FIG. 19, in a case where the second electrode plate of the storage capacitor C2 is electrically connected to the first electrode plate of the coupling capacitor C1 at the second node N2, the storage capacitor C2 can store the potential at the second node N2. During the period when the pixel circuit PX performs the data writing, the potential at the second node N2 is changed, and the storage capacitor C2 can store a changed potential at the second node N2 without interfering the potential change amount ΔVN2 at the second node N2 from being coupled to the first node N1, and a potential change amount ΔVN1 at the first node N1 satisfies ΔVN1=ΔVN2. During the period when the pixel circuit PX drives the light-emission element LED to emit light to display an image, the storage capacitor C2 can keep the potential at the second node N2 stable and thus keep the first node N1 stable, so that the pixel circuit PX provides a stable driving current to the light-emission element LED, and the driving current Id=B×ΔVN1²=B×ΔVN2²=B×(Data−Vref3)², and B=(1/2)×μ×Cₒₓ×(W/L).

Referring to FIG. 20, when the second electrode plate of the storage capacitor C2 is electrically connected to the second electrode plate of the coupling capacitor C1 at the first node N1, the storage capacitor C2 can store the potential at the first node N1. During the period when the pixel circuit PX performs the data writing, the potential at the second node N2 changes, and the storage capacitor C2 interferes the potential change amount ΔVN2 at the second node N2 from being coupled to the first node N1, so that the potential change amount ΔVN1 at the first node N1 satisfies ΔVN1=ΔVN2×[C1/(C1+C2)]. During the period when the pixel circuit PX drives the light-emission element LED to emit light to display an image, the storage capacitor C2 can keep the potential at the first node N1 stable, so that the pixel circuit PX provides a stable driving current to the light-emission element LED, and the driving current Id=B×ΔVN1²=B×[ΔVN2×C1/(C1+C2)]²=B×[(Data−Vref3)×C1/(C1+C2)]², and B=(1/2)×μ×Cₒₓ×(W/L).

In a case where the storage capacitor C2 is connected to the first node N1, magnitudes of capacitances of the storage capacitor C1 and the coupling capacitor C2 are adjusted to adjust the driving current, and with a same small driving current, the magnitudes of the capacitances of the storage capacitor C1 and the coupling capacitor C2 are adjusted to adjust the data signal Data. For example, in a case where Id=B×4, and 0 V<Data<Vref3=4 V, as C2/(C1+C2) decreases, |Data−Vref3|gradually increases, and Data gradually decreases, which facilitates reducing the power consumption on the data line Data_L, increasing the charging rate, and realizing high resolution and high refresh rate. In a case where Id=B×4, and Data<Vref3=0 V, as C1/(C1+C2) decreases, |Data−Vref3| gradually increases, and |Data|gradually increases, which also facilitates expanding an adjustment range of the Data on the data line Data_L, realizing a precise adjustment of the driving current, and improving a display contrast.

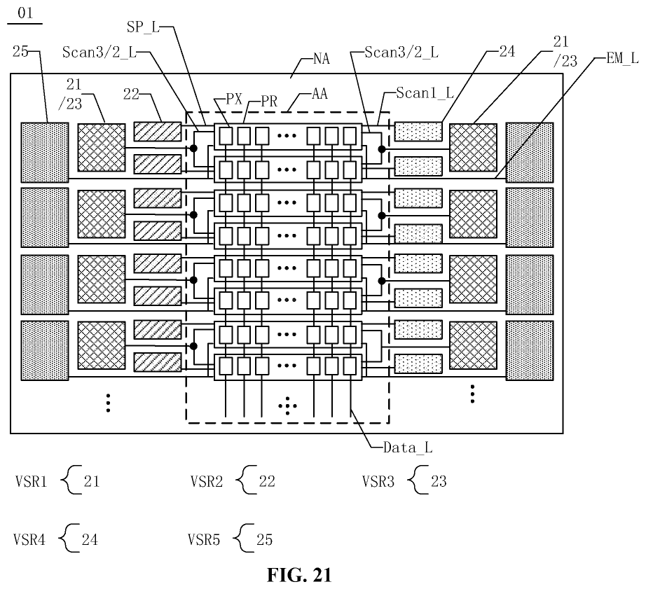

FIG. 21 is a top structural view of another display panel provided in some embodiments of the present disclosure. Optionally, referring to FIG. 20 and FIG. 21, the pixel circuit PX further includes an initialization module 17 including an initialization transistor M5. The initialization transistor M5 includes a first electrode configured to receive an initialization signal Vref1, and a second electrode electrically connected to the gate of the driver transistor M3 at the first node N1. The display panel 01 further includes a fourth driving circuit VSR4 including multiple fourth shift register units 24, and the fourth shift register units 24 are electrically connected to a gate of the initialization transistor M5. The fourth driving circuit VSR4 is configured to sequentially control the initialization transistors M5 in a row of the pixel circuits PX to initialize the first node N1. In a same pixel circuit PX, the gate of the second reset transistor M7 of the reset module 15 can also be connected to the gate of the initialization transistor M5 of the initialization module 17 in a same fourth shift register unit 24.

Exemplarily, the first electrode of the initialization transistor M5 can be electrically connected to a first reference voltage terminal (not shown in the figures) through the first reset line Vref1_L to receive the initialization signal Vref1, and the gate of the initialization transistor M5 can be electrically connected to the fourth shift register unit 24 through the initialization scanning line Scan1_L to receive an initialization scanning signal Scan1. In some optional embodiments, the first reference voltage terminal can multiplex the second reference voltage terminal, and the first reset line Vref1_L can multiplex the second reset line Vref2_L.

Within a display period of a frame, in a same pixel circuit PX, the initialization transistor M5 can be turned on before the compensation transistor M4 is turned on, to initialize the first node N1, clear the electrical signal remaining at the first node N1 within a display period of a previous frame, and control the driver transistor M3 to be turned on completely. In this way, when the pixel circuit PX begins to perform the threshold compensation, the first power supply signal PV1 of the first power supply terminal can be transmitted to the first node N1 through the driver transistor M3 and the compensation transistor M4, and the Vgs of the driver transistor M3 can approach towards Vth continuously, so that the driver transistor M3 can reach the critical state of an off-state, and at this time, VN1=PV1+Vth, and the threshold voltage Vth can be fully compensated to the first node N1, and the driving current Id is not interfered with the Vth of the driver transistor M3 when the pixel circuit PX emits light to display an image.

Based on the above embodiments, in a same pixel circuit PX within a display period of a frame, a period when the pixel circuit PX initializes the first node N1 is prior to the period when the pixel circuit PX performs the threshold compensation.

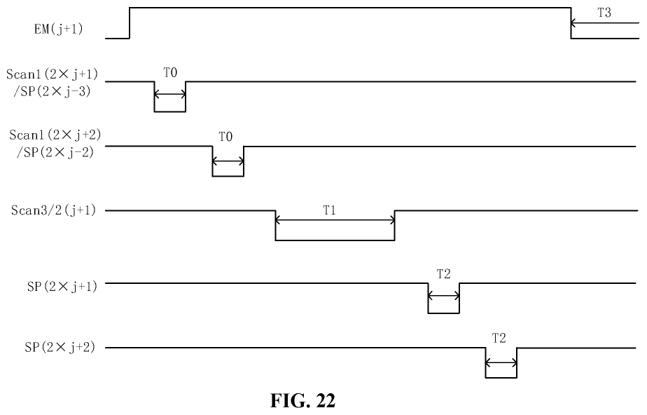

Exemplarily, the following continues to describe with the example where the pixel group includes two pixel rows PR, the enable level is the low level, and the disable level is the high level. FIG. 22 is a schematic diagram of a timing sequence of another pixel group provided in some embodiments of the present disclosure, and a driving timing sequence in FIG. 22 corresponds to the pixel circuit in FIG. 19 or FIG. 20. Referring to FIG. 19 to FIG. 22, the gates of the initialization transistors M5 in the (2×j−1)-th row can receive a (2×j−1)-th initialization scanning signal Scan1(2×j−1) output from the (2×j−1)-th fourth shift register unit 24(2×j−1), and the gates of the initialization transistors M5 in the (2×j)-th row can receive a (2×j)-th initialization scanning signal Scan1(2×j) output from the (2×j)-th fourth shift register unit 24(2×j).

Within a display period of a frame, the pixel circuit PX includes an initialization phase T0 located before the compensation phase T1. During the initialization phase T0, the initialization scanning signal Scan1 is at an enable level, the compensation scanning signal Scan3, the reset scanning signal Scan2, the writing scanning signal SP, and the light-emission control signal EM each are at a disable level, the initialization transistor M5 is turned on, and the compensation transistor M4, writing transistor M2, and light-emission control transistor M6 are turned off. The initialization signal Vref1 of the first reset line Vref1_L can be transmitted to the gate of the driver transistor M3 through the initialization transistor M5 to initialize the driver transistor M3 so that the driver transistor M3 is fully are turned on.

In some optional embodiments, the fourth shift register unit 24 is electrically connected to the gates of the initialization transistors M5 in a row of the pixel circuit PX, the fourth shift register unit 24 multiplexes the second shift register unit 22, and the gates of the initialization transistors M5 in the i-th row of the pixel circuits PX and the gates of the writing transistors M2 in an (i-r)-th row of the pixel circuits PX are connected to a same second shift register unit 22, where i and r are integers and i>r≥2.

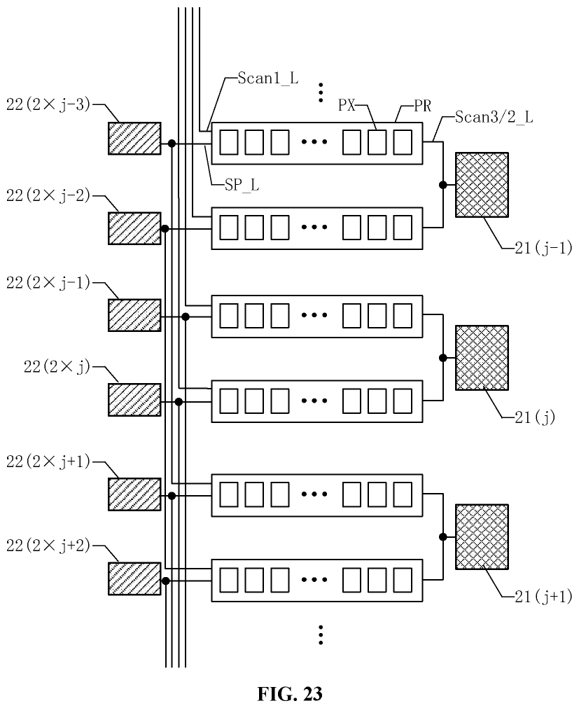

Exemplarily, the description is continued with the example where the pixel group includes two pixel rows PR, the enable level is the low level, and the disable level is the high level. FIG. 23 is a partial top view of another display panel provided in some embodiments of the present disclosure. Referring to FIG. 19, FIG. 20, FIG. 22, and FIG. 23, the gates of the initialization transistors M5 in the (2×j+1)-th row and the gates of the writing transistors M2 in the (2×j−3)-th row can be electrically connected to the (2×j−3)-th second shift register unit 22(2×j−3), and the gate of the initialization transistor M5 in the (2×j+1)-th row can receive the (2×j−3)-th writing scanning signal SP(2×j−3) output from the (2×j−3)-th second shift register unit 22(2×j−3) as an initialization scanning signal Scan1(2×j+1).

The gates of the initialization transistors M5 in the (2×j+2)-th row and the gates of the writing transistors M2 in the (2×j−2)-th row can be electrically connected to the (2×j−2)-th second shift register unit 22(2×j−2), and the gate of the initialization transistor M5 in the (2×j+2)-th row can receive the (2×j−2)-th writing scanning signal SP(2×j−2) output from the (2×j−2)-th second shift register unit 22(2×j−2) as an initialization scanning signal Scan1(2×j+2). In this way, the number of the driving circuits can be reduced by multiplexing the shift register unit and multiplexing signal, which facilitates realizing the narrow bezel of the display panel 01, and also facilitates the circuit arrangement and simplifying the layout difficulty.

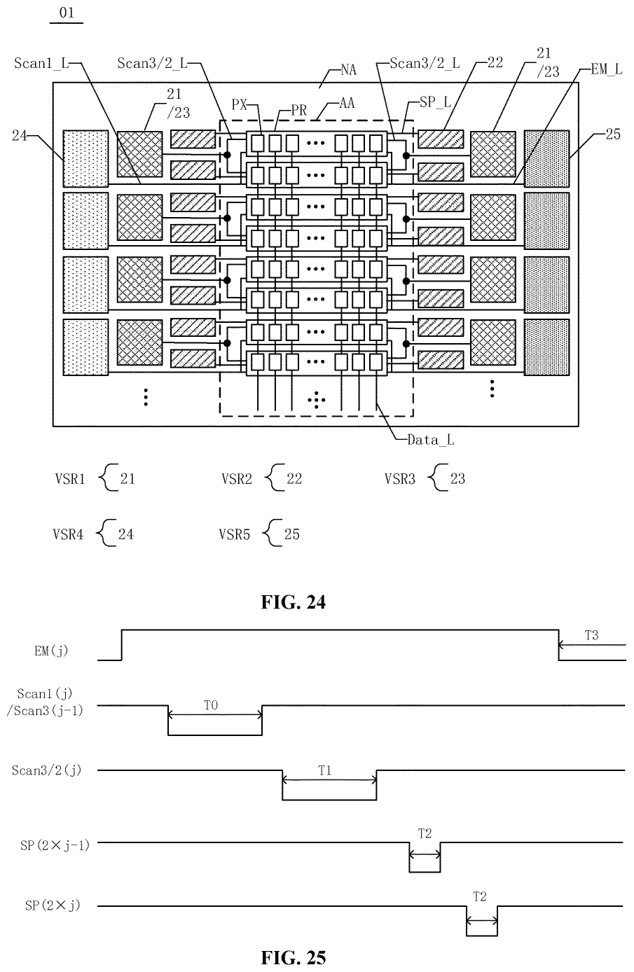

FIG. 24 is a top structural view of another display panel provided in some embodiments of the present disclosure. In other optional embodiments, referring to FIG. 19, FIG. 20, and FIG. 24, the fourth shift register unit 24 is electrically connected to the gates of the initialization transistors M5 in multiple rows of the pixel circuits PX in a same pixel group.

Specifically, the gates of the initialization transistors M5 in the (2×j−1)-th row and the gates of the initialization transistors M5 in the (2×j)-th row can receive a j-th initialization scanning signal Scan1(j) output from a j-th fourth shift register unit 24(j). Within a display period of a frame, the number of the initialization scanning signals Scan1 output by the fourth driving circuit VSR4 and times that the fourth driving circuit VSR4 outputs the initialization scanning signal Scan1 can be equal to the number of the compensation scanning signals Scan3 output by the first driving circuit VSR1 and times that the first driving circuit VSR1 outputs the compensation scanning signal Scan3, respectively, both the number of the initialization scanning signals Scan1 output by the fourth driving circuit VSR4 and the number of the compensation scanning signals Scan3 output by the first driving circuit VSR1 are smaller than the number of the writing scanning signals SP output by the second driving circuit VSR2, and both the times that the fourth driving circuit VSR4 outputs the initialization scanning signal Scan1 and the times that the first driving circuit VSR1 outputs the compensation scanning signal Scan3 are smaller than the times that the second driving circuit VSR2 outputs the writing scanning signal SP. In this way, it is conducive to reducing the number of the fourth shift register units 24 in the fourth driving circuit VSR4, simplifying the circuit arrangement, and reducing their occupied space, thereby realizing the thin and light display panel 01 and the narrow bezel.

On the basis of the above embodiments, the fourth shift register unit 24 multiplexes the first shift register unit 21, and the initialization module 17 in the j-th pixel group and the compensation module 13 in a (j-s)-th pixel group are connected to a same first shift register unit 21, where j and s are integers and j>s≥1.

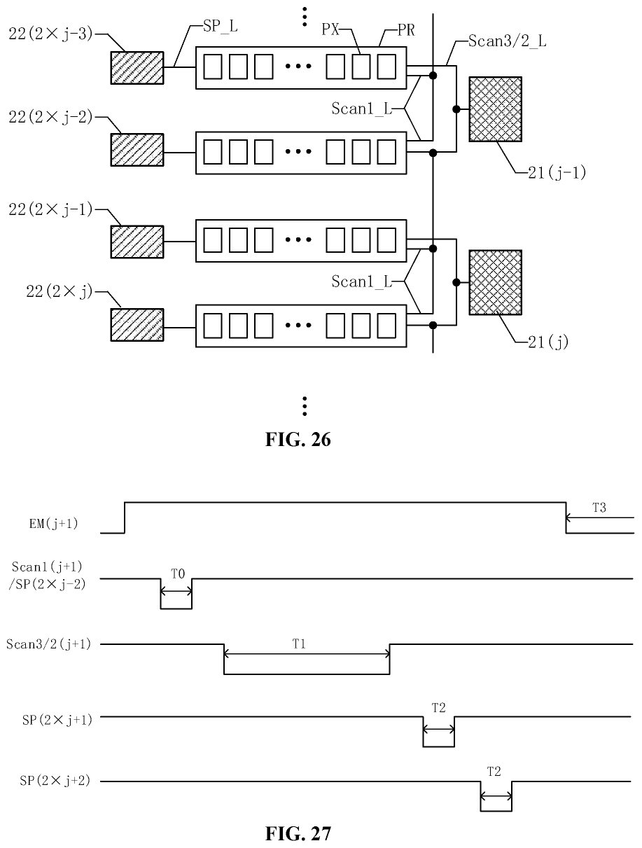

Exemplarily, the description is continued with the example where the pixel group includes two pixel rows PR, the enable level is the low level, and the disable level is the high level. FIG. 25 is a schematic diagram of a timing sequence of another pixel group provided in some embodiments of the present disclosure, and a driving timing sequence in FIG. 25 corresponds to the pixel circuit in FIG. 19 or FIG. 20. FIG. 26 is a partial top view of another display panel provided in some embodiments of the present disclosure. Referring to FIG. 19, FIG. 20, FIG. 25, and FIG. 26, the gates of the initialization transistors M5 in the (2×j−1)-th row and the gates of the initialization transistors M5 in the (2×j−1)-th row can be electrically connected to the (j−1)-th first shift register unit 21(j−1), and the gates of the initialization transistors M5 in the (2×j−1)-th row and the gates of the initialization transistors M5 in the (2×j)-th row can receive the (j−1)-th compensation scanning signal Scan3(j−1) outputted by the (j−1)-th first shift register unit 21(j−1) as the initialization scanning signal Scan1(j). The number of the driving circuits can be reduced by multiplexing the shift register unit and multiplexing the signal, which facilitates realizing the narrow bezel of the display panel 01, and also facilitates the circuit arrangement and simplifying the layout difficulty.

On the basis of the above embodiments, the fourth shift register unit 24 can multiplex the second shift register unit 22, and the gates of the initialization transistors M5 in the pixel circuits PX in the j-th pixel group and the gates of the writing transistors M2 in a ((j−1)×k−q)-th row of the pixel circuits PX, where j, k, and q are integers, j>1, k is the row number of the rows of the pixel circuits PX in the group number, and q≥1.

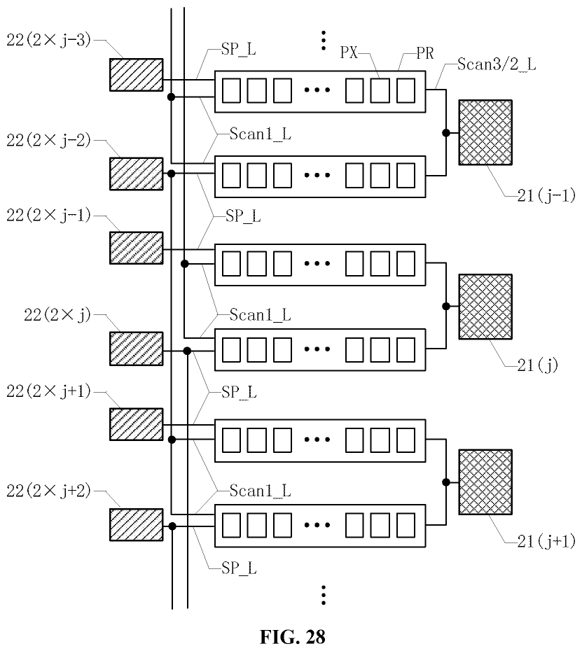

Exemplarily, the description is continued with the example where the pixel group includes two pixel rows PR, the enable level is the low level, and the disable level is the high level. FIG. 27 is a schematic diagram of a timing sequence of another pixel group provided in some embodiments of the present disclosure, and a driving timing sequence in FIG. 27 corresponds to the pixel circuit in FIG. 19 or FIG. 20. FIG. 28 is a partial top view of another display panel provided in some embodiments of the present disclosure. Referring to FIG. 19, FIG. 20, FIG. 27, and FIG. 28, the gates of the initialization transistors M5 in the (2×j+1)-th row and the gates of the initialization transistors M5 in the (2×j+2)-th row can be electrically connected to the (2×j−2)-th second shift register unit 22(2×j−2), and can receive the (2×j−2)-th writing scanning signal SP(2×j−2) outputted from the (2×j−2)-th second shift register unit 22(2×j−2) as an initialization scanning signal Scan1(j+1).

In this way, while reducing the number of the driving circuits, the writing scanning signal SP is multiplexed as the initialization signal Scan1, which facilitates shortening a duration for the pixel circuit PX to perform initialization, thereby increasing the duration for the pixel circuit PX to perform the threshold compensation, increasing the charging rate of the threshold compensation, and then improving the display uniformity.

In other optional embodiments, the gates of the initialization transistors M5 in the (2×j+1)-th pixel row PR(2×j+1) and the gates of the initialization transistors M5 in the (2×j+2)-th pixel row PR(2×j+2) can also be electrically connected to the (2×j−3)-th second shift register unit 22(2×j−3) or the (2×j−4)-th second shift register unit 22(2×j−4) and receive the writing scanning signal SP(2×j−3) or the writing scanning signal SP(2×j−4) as the initialization scanning signal Scan1(j+1) to satisfy that, within a display period of a frame, the period when the pixel circuit PX initializes the first node N1 is prior to the period when the pixel circuit PX performs the threshold compensation.

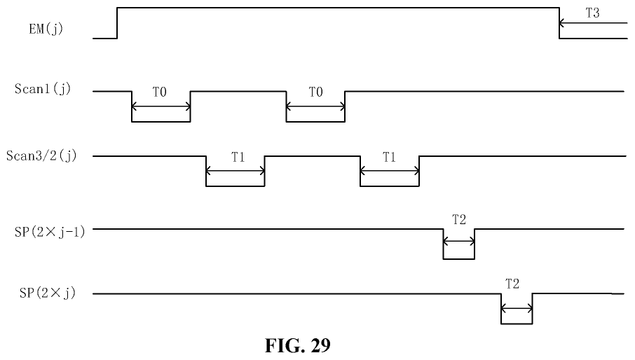

FIG. 29 is a schematic diagram of a timing sequence of another pixel group provided in some embodiments of the present disclosure, and a driving timing sequence in FIG. 29 corresponds to the pixel circuit in FIG. 19 or FIG. 20. Optionally, referring to FIG. 19, FIG. 20, and FIG. 29, within a display period of a frame, the periods when the pixel circuit PX initializes the first node N1 alternate with the periods when the pixel circuit PX performs the threshold compensation, and the period when the pixel circuit PX performs the threshold compensation is a last period among the periods when the pixel circuit PX initializes the first node N1 and the periods when the pixel circuit PX performs the threshold compensation.

Exemplarily, the description is continued with an example where the pixel group includes two pixel rows PR, the enable level is the low level, the disable level is the high level, and the gates of the initialization transistors M5 in a same pixel group can receive a same initialization scanning signal Scan1. Within a display period of a frame, the pixel circuit PX includes an initialization phase T0, a compensation phase T1, a writing phase T2, and a light-emission phase T3. Within a display period of a frame, the pixel circuit PX include multiple initialization phases T0 and multiple compensation phases T1. Before the pixel circuit PX performs the data writing, the pixel circuit PX can initialize the first node N1 for multiple times, and the pixel circuit PX can also perform the threshold compensation for multiple times. The first node N1 is reset with alternated high and low potentials for multiple times, which can prevent the interference of a bias voltage of the driver transistor M3, thereby avoiding a hysteresis of the driver transistor M3. When switching a black image to a white image, the brightness of the white image can be reached quickly to avoid a residual shadow.

It should be noted that the figure only exemplarily shows that the pixel circuit PX includes two initialization phases T0 and two compensation phases T1 within a display period of a frame. In other embodiments, within a display period of a frame, the pixel circuit PX can also include more than two initialization phases T0, and/or, more than two compensation phases T1. The embodiments of the present disclosure does not limit the number of the initialization phases T0 and the number of the compensation phases T1 of the pixel circuit PX within a display period of a frame.

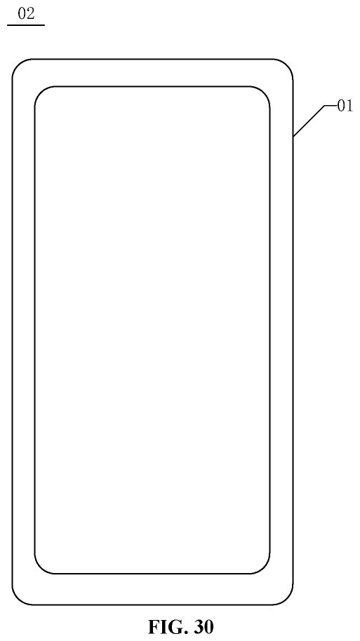

According to a same inventive concept, some embodiments of the present disclosure also provide a display apparatus. FIG. 30 is a schematic structural diagram of a display apparatus provided in some embodiments of the present disclosure. As shown in FIG. 30, the display apparatus 02 includes the display panel 01 provided in any one of the embodiments of the present disclosure. The display apparatus 02 provided in the embodiments of the present disclosure can be a cellular phone as shown in FIG. 30, or it can also be any electronic product having a display function, including but not limited to, a television, a laptop computer, a desktop display, a tablet computer, a digital camera, a smart bracelet, smart glasses, an in-vehicle display, a medical device, an industrial control device, a touch interaction terminal, and the like, which are not limited by the embodiments of the present disclosure.

Note that the foregoing illustrates only exemplary embodiments of the present disclosure and their utilized technical principles. It will be understood by those skilled in the art that the present disclosure is not limited to the specific embodiments herein, and various obvious equivalent modifications, re-adjustments, and replacements that are made by those skilled in the art without departing from the protection scope of the present disclosure. Therefore, although the present disclosure has been described in detail in above embodiments, the present disclosure is not limited to these embodiments and can include more equivalent embodiments without departing from the concept of the present disclosure, and the scope of the present disclosure is determined by the scope of the appended claims.

What is claimed is:

1. A display panel, comprising:
a plurality of pixel circuits arranged in an array, wherein each of the plurality of pixel circuits comprises a driver transistor, a writing module, a coupling module, a compensation module, and a light-emission element, wherein
the writing module is electrically connected to a gate of the driver transistor through the coupling module,
the compensation module is electrically connected between the gate of the driver transistor and a drain of the driver transistor,
the light-emission element is electrically connected to the driver transistor, and
a plurality of pixel rows of the plurality of pixel circuits form a pixel group; and
a first driving circuit and a second driving circuit, wherein
the first driving circuit is configured to sequentially control the compensation modules in the plurality of pixel rows in each of the pixel groups to perform a threshold compensation on the driver transistors of the plurality of pixel circuits,
the second driving circuit is configured to sequentially control the writing modules in each of the plurality of pixel rows to write a data signal to the gates of the driver transistors of the plurality of the pixel circuits,
the first driving circuit comprises a plurality of first shift register units, each of the plurality of first shift register units is electrically connected to the compensation modules in the plurality of pixel rows of the pixel circuits in a same one of the plurality of the pixel groups, and
the second driving circuit comprises a plurality of second shift register units, and each of the second shift register units is electrically connected to the writing modules in a corresponding one of the plurality of pixel rows.

2. The display panel according to claim 1, wherein in a same one of the plurality of pixel circuits, a period when the pixel circuit performs threshold compensation is prior to a period when the pixel circuit performs data writing, and the period when the pixel circuit performs the threshold compensation and the period when the pixel circuit performs the data writing do not overlap.

3. The display panel according to claim 1, wherein the writing module comprises a writing transistor, the writing transistor comprises a first electrode configured to receive the data signal, and a second electrode electrically connected to a first terminal of the coupling module at a second node, and a gate electrically connected to one second shift register unit of the plurality of second shift register units; and
the compensation module comprises a compensation transistor, the compensation transistor comprises a first electrode electrically connected to the drain of the driver transistor, and a second electrode electrically connected to the gate of the driver transistor, and a gate electrically connected to one first shift register unit of the plurality of first shift register units.

4. The display panel according to claim 3, further comprising:
a third driving circuit,
wherein the writing module further comprises a first reset transistor, and the first reset transistor comprises a first electrode configured to receive a first reset signal, and a second electrode electrically connected to the second node;
the third driving circuit is configured to sequentially control the first reset transistors in each of the plurality of pixel rows to reset the second nodes; and
the third driving circuit comprising a plurality of third shift register units, wherein one third shift register unit of the plurality of third shift register units is electrically connected to a gate of the first reset transistor.

5. The display panel according to claim 4, wherein in a same one of the plurality of pixel circuits, a period when the pixel circuit resets the second node and a period when the pixel circuit performs the threshold compensation overlap.

6. The display panel according to claim 4, wherein each of the plurality of third shift register units is electrically connected to the gates of the first reset transistors in a corresponding one of the plurality of pixel rows; and
the plurality of second shift register units also serve as the plurality of third shift register units, and the gates of the first reset transistors in an i-th row of the plurality of pixel circuits and the gates of the writing transistors in an (i-e)-th row of the plurality of pixel circuits are connected to a same second shift register unit of the plurality of second shift register units, where i and e are integers, and i>e≥2.

7. The display panel according to claim 4, wherein each of the plurality of third shift register units is electrically connected to the gates of the first reset transistors in the plurality of pixel rows of the pixel circuits in a same one of the plurality of the pixel groups.

8. The display panel according to claim 7, wherein the plurality of second shift register units also serve as the plurality of third shift register units; and
the gates of the first reset transistors of the pixel circuits in a j-th pixel group of the plurality of the pixel groups and the gates of the writing transistors in a ((j−1)×k−p)-th row of the plurality of pixel circuits are connected to a same one of the plurality of second shift register units,
where j, k, and p are integers, j>1, k represents a row number of the plurality of pixel rows of the pixel circuits in each of the plurality of the pixel groups, and p≥0.

9. The display panel according to claim 7, wherein the plurality of first shift register units also serve as the plurality of third shift register units; and
in a same one of the plurality of pixel circuits, the gate of the first reset transistor and the gate of the compensation transistor are connected to a same one of the plurality of first shift register units.

10. The display panel according to claim 1, wherein the coupling module comprises a coupling capacitor, and the pixel circuit further comprises a storage module comprising a storage capacitor; and
the storage capacitor comprises a first electrode plate electrically connected to a first power supply terminal, and a second electrode plate electrically connected to a first electrode plate of the coupling capacitor or a second electrode plate of the coupling capacitor.

11. The display panel according to claim 1, further comprising:
a fourth driving circuit,
wherein the pixel circuit further comprises an initialization module comprising an initialization transistor, the initialization transistor comprises a first electrode configured to receive an initialization signal, and a second electrode electrically connected to a first node electrically connected to the gate of the driver transistor;
the fourth driving circuit is configured to sequentially control the initialization transistors in each of the pixel rows to initialize the first nodes in each of the rows of the plurality of pixel circuits; and
the fourth driving circuit comprises a plurality of fourth shift register units, and each of the plurality of fourth shift register units is electrically connected to gates of the initialization transistors in a corresponding row of the plurality of pixel circuits.

12. The display panel according to claim 11, wherein within a display period of a frame, in a same one of the plurality of pixel circuits, a period when the pixel circuit initializes the first node is prior to a period when the pixel circuit performs the threshold compensation.

13. The display panel according to claim 11, wherein the writing module comprises a writing transistor, the writing transistor comprises a first electrode configured to receive the data signal, a second electrode electrically connected to a second node electrically connected to a first terminal of the coupling module, and a gate electrically connected to one second shift register unit of the plurality of second shift register units;
each of the plurality of second shift register units is electrically connected to the gates of the initialization transistors in a corresponding row of the plurality of pixel circuits; and
the plurality of second shift register units also server as the plurality of fourth shift register units, and the gates of the initialization transistors in an i-th row of the plurality of pixel circuits and the gates of the writing transistors in an (i-r)-th row of the plurality of pixel circuits are connected to a same one of the plurality of second shift register units, where i and r are integers, and i>r≥2.

14. The display panel according to claim 11, wherein each of the plurality of fourth shift register units is electrically connected to the gates of the initialization transistors in the plurality of pixel rows of the pixel circuits in a same one of the pixel groups.

15. The display panel according to claim 14, wherein the plurality of first shift register units also serve as the plurality of fourth shift register units, and the initialization modules in a j-th pixel group of the plurality of the pixel groups and the compensation modules in a (j-s)-th pixel group of the plurality of the pixel groups are connected to a same one of the plurality of first shift register units, where j and s are integers, and j>s≥1.

16. The display panel according to claim 14, wherein
the plurality of second shift register units also serve as the plurality of fourth shift register units, and
the gates of the initialization transistors of the pixel circuits in a j-th pixel group of a plurality of the pixel groups and the gates of the writing transistors in a ((j−1)×k−q)-th row of the plurality of pixel circuits are connected to a same one of the plurality of second shift register units,
where j, k, and q are integers, j>1, k represents a row number of the plurality of pixel rows of pixel circuits in each of the plurality of the pixel groups, and q≥1.

17. The display panel according to claim 11, wherein within a display period of a frame, in a same one of the plurality of pixel circuits, periods when the pixel circuit initializes the first node alternate with periods when the pixel circuit performs the threshold compensation, and one of the periods when the pixel circuit performs the threshold compensation is a last period among the periods when the pixel circuit initializes the first node and the periods when the pixel circuit performs the threshold compensation.

18. The display panel according to claim 1, further comprising:
a fifth driving circuit, wherein the pixel circuit further comprises a light-emission control module electrically connected between the driver transistor and the light-emission element, and the fifth driving circuit is configured to sequentially turn on the light-emission control modules in the plurality of pixel rows of the pixel circuits in each of the plurality of the pixel groups.

19. The display panel according to claim 1, wherein the pixel circuit further comprises a reset module electrically connected to the light-emission element; and
wherein in a same one of the plurality of pixel circuits,
the reset module and the compensation module are connected to a same one of the plurality of first shift register units, or
the reset module and the writing module are connected to a same one of the plurality of second shift register units.

20. A display apparatus, comprising a display panel comprising:
a plurality of pixel circuits arranged in an array, wherein each of the plurality of pixel circuits comprises a driver transistor, a writing module, a coupling module, a compensation module, and a light-emission element, wherein
the writing module is electrically connected to a gate of the driver transistor through the coupling module,
the compensation module is electrically connected between the gate of the driver transistor and a drain of the driver transistor,
the light-emission element is electrically connected to the driver transistor, and
a plurality of pixel rows of the plurality of pixel circuits form a pixel group; and
a first driving circuit and a second driving circuit, wherein
the first driving circuit is configured to sequentially control the compensation modules in the plurality of pixel rows in each of the pixel groups to perform a threshold compensation on the driver transistors of the plurality of pixel circuits,
the second driving circuit is configured to sequentially control the writing modules in each of the plurality of pixel rows to write a data signal to the gates of the driver transistors of the plurality of the pixel circuits,
the first driving circuit comprises a plurality of first shift register units, each of the plurality of first shift register units is electrically connected to the compensation modules in the plurality of pixel rows of the pixel circuits in a same one of the plurality of the pixel groups, and
the second driving circuit comprises a plurality of second shift register units, and each of the second shift register units is electrically connected to the writing modules in a corresponding one of the plurality of pixel rows.
